(19) United States
(12) Patent Application Publication
(10) Pub. No.: US 2026/0290105 A1
(43) Pub. Date: Sep. 24, 2026

(54) SYSTEM

(71) Applicant: SoftBank Group Corp., Tokyo (JP)

(72) Inventor: Shoei TAKEMOTO, Tokyo (JP)

(73) Assignee: SoftBank Group Corp., Tokyo (JP)

(21) Appl. No.: 19/562,772

(22) Filed: Mar. 11, 2026

(30) Foreign Application Priority Data
Mar. 19, 2025 (JP) 2025-044994

(51) Int. Cl. G07C 13/00; G06N 5/022

(52) U.S. Cl. CPC G07C 13/00; G06N 5/022

(57) ABSTRACT

A system includes a processor that is configured to input, into a generative artificial intelligence model, a prompt that instructs the generative artificial intelligence model to generate personality objects based on small-scale pre-election survey results for each electoral district and demographic information, input, into the generative artificial intelligence model, a prompt that instructs the generative artificial intelligence model to perform a simulation for predicting a winning candidate in an election by using the generated personality objects, and input, into the generative artificial intelligence model, a prompt that instructs the generative artificial intelligence model to analyze prediction results and output the prediction results in an appropriate format for sale of the prediction results to information media.

### CROSS-REFERENCE TO RELATED APPLICATION

This application is based on and claims priority under 35 USC 119 from Japanese Patent Application No. 2025-044994 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional election prediction techniques rely heavily on small-scale surveys and manual or semi-automatic statistical models. When only a limited number of respondents can be collected in each electoral district, conventional methods struggle to accurately represent the full spectrum of voters and their attributes, such as age, gender, occupation, and education level, within each district. As a result, the prediction accuracy of winning candidates is often insufficient, especially in districts with complex or heterogeneous demographics.

Furthermore, existing systems typically require specialized expertise to design and implement the prediction models, which makes it difficult for media organizations or other users to flexibly and rapidly update prediction logic in response to changes in available data or analytical requirements. In addition, conventional systems do not effectively utilize generative artificial intelligence to systematically construct large-scale synthetic voter populations and corresponding simulation processes, and they frequently lack mechanisms to automatically produce prediction results in forms that are directly usable and commercially valuable to different kinds of information media, such as national newspapers, local newspapers, and television.

Therefore, there is a need for a system that can leverage generative artificial intelligence models to: (i) generate personality objects representing large numbers of synthetic voters based on small-scale survey results and demographic information for each electoral district, (ii) perform simulations to predict winning candidates using those personality objects, and (iii) automatically analyze and output prediction results in appropriate formats suitable for distribution and sale to various information media.

### SUMMARY

To solve the above-described problems, an embodiment of the present invention provides a system comprising a processor configured to interact with a generative artificial intelligence model through prompts so as to implement, in an integrated and automated manner, generation of personality objects, simulation of election outcomes, and preparation of commercially usable prediction results.

Specifically, the processor is configured to input, into a generative artificial intelligence model, a prompt that instructs the generative artificial intelligence model to generate personality objects based on small-scale pre-election survey results for each electoral district and demographic information, and, in some embodiments, based on demographic data of each electoral district.

Through this processing, the generative artificial intelligence model generates a large number of personality objects that statistically reflect the demographic structure of each electoral district and the voting tendencies indicated by the small-scale pre-election surveys.

The processor is further configured to input, into the generative artificial intelligence model, a prompt that instructs the generative artificial intelligence model to perform a simulation for predicting a winning candidate in an election by using the generated personality objects. In response to this prompt, the generative artificial intelligence model executes a simulation in which each personality object is associated with one of a plurality of candidates, thereby producing prediction results such as predicted vote counts or vote shares for each candidate in each electoral district.

Moreover, the processor is configured to input, into the generative artificial intelligence model, a prompt that instructs the generative artificial intelligence model to analyze the prediction results and output or provide the prediction results in an appropriate format for sale to information media. In one embodiment, the processor inputs a prompt that instructs the generative artificial intelligence model to analyze the prediction results and provide the prediction results in an appropriate format to media including national newspapers, local newspapers, and television. As a result, the system automatically transforms raw simulation outputs into structured reports, summaries, or visualizable data formats that can be directly utilized in media reporting, thereby improving the commercial usability and distribution efficiency of election prediction information.

The term “processor” refers to one or more hardware-based processing units, such as a central processing unit (CPU), graphics processing unit (GPU), application-specific integrated circuit (ASIC), or other computing circuitry, and may further encompass combinations of such units configured to execute instructions and perform the functions described herein.

The term “generative artificial intelligence model” refers to a machine learning model, such as a neural network-based model, that is capable of generating output data, including text, numerical data, or structured objects, in response to input data or prompts, and that is used in the present invention to generate personality objects, perform simulations, and analyze prediction results.

The term “prompt” refers to information, typically expressed in natural language or structured input format, that is provided to a generative artificial intelligence model in order to instruct the model to perform a specific task or series of tasks, such as generating personality objects, running an election simulation, or formatting prediction results.

The term “personality object” refers to a data structure or record that represents a synthetic voter or virtual individual associated with an electoral district, the data structure including at least demographic attributes and voting tendency information, and being used as a unit in election simulation processing.

The term “small-scale pre-election survey results” refers to survey data obtained from a relatively limited number of respondents in each electoral district before an election, the survey data including information such as respondent attributes and intended voting preferences.

The term “demographic information” refers to statistical information relating to the characteristics of a population in an electoral district, including but not limited to age distribution, gender distribution, occupation distribution, education level distribution, or other population attributes.

The term “demographic data of each electoral district” refers to demographic information that is associated with and specific to a particular electoral district, such that the demographic structure of that district can be represented and used for generating personality objects.

The term “simulation for predicting a winning candidate in an election” refers to processing in which multiple personality objects are used to virtually assign votes to one of a plurality of candidates under defined rules or models, and in which aggregated results are used to estimate which candidate is most likely to win in an electoral district.

The term “prediction results” refers to data that indicates the outcome of the simulation, including but not limited to predicted vote counts, vote shares, rankings, or winning probabilities for one or more candidates in one or more electoral districts.

The term “information media” refers to entities or channels that disseminate information to the public or specific audiences, including, for example, national newspapers, local newspapers, television broadcasters, online news platforms, and other media organizations.

The term “appropriate format” refers to a data format or presentation style of prediction results that is suitable for direct use by information media, such as formatted reports, tables, charts, textual summaries, or machine-readable data files that can be integrated into media production systems.

The term “media including national newspapers, local newspapers, and television” refers to a subset of information media that specifically comprises large-scale newspapers distributed nationwide, newspapers primarily distributed in limited geographic regions, and television broadcasters operating at national or regional levels.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

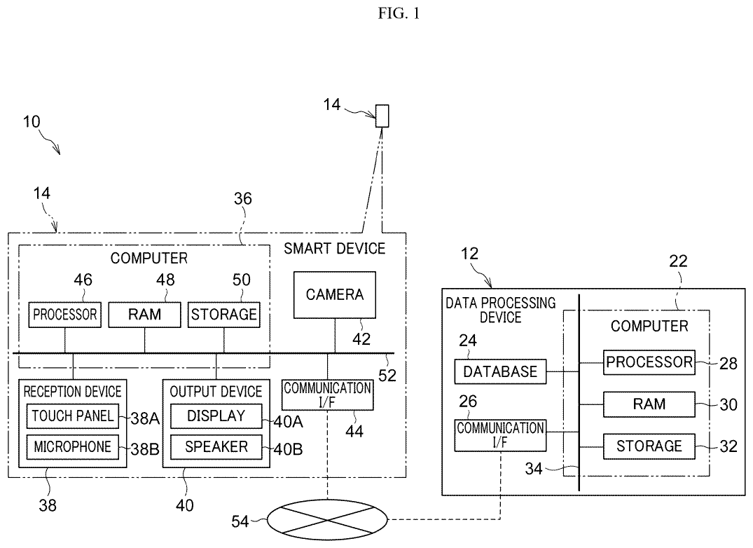

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

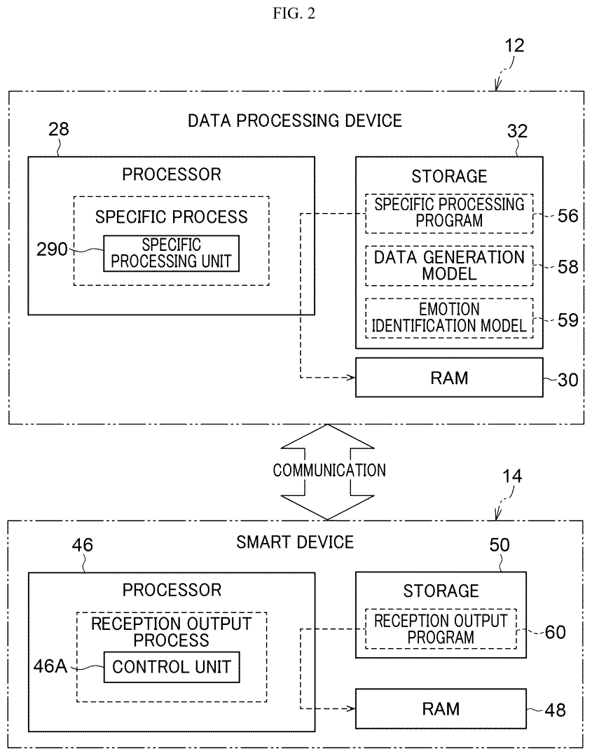

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a

Conventional election forecasting systems typically rely on static statistical models and manually curated sampling procedures. Such systems encounter several technical problems in a computing environment.

First, conventional systems cannot efficiently construct large-scale, high-resolution individual-level datasets that reflect fine-grained demographic structures of each electoral region. They are constrained by limited raw survey data and simple upscaling techniques, which leads to sparse or biased input data structures in memory and storage. As a result, downstream simulation modules operating on such data structures exhibit unstable performance and low predictive accuracy.

Second, the processing pipeline from raw survey data acquisition to simulation-ready data often involves disparate tools and ad hoc scripts. Missing-value handling, outlier removal, categorical normalization, and aggregation are performed in uncoordinated stages. This causes redundant data transfers between storage units, inconsistent preprocessing logic across runs, and increased computational overhead. The lack of a unified programmatic pipeline degrades the efficiency, reproducibility, and maintainability of the overall computing system.

Third, while generative AI models are capable of producing synthetic data, typical usages invoke such models in an unstructured, manual manner. Prompt sentences are crafted ad hoc by human operators and are not systematically derived from machine-readable demographic indicators.

Consequently, the generative AI model often produces inconsistent or ill-constrained synthetic individuals that do not align with actual demographic distributions, leading to a mismatch between generated data structures and the intended population profile. This mismatch further propagates error into simulation modules and reduces the utility of synthetic data.

Fourth, conventional systems do not tightly couple simulation outputs with automated formatting and explanation generation tailored to heterogeneous output channels. When forecast results must be delivered to different information media, engineers typically implement custom formatting code per channel. This leads to duplicated logic, fragmented code bases, and high maintenance costs. Moreover, explanation text and visual summaries are often generated manually, which introduces latency and variability in the quality of explanation information.

Fifth, conventional architectures do not exploit a feedback loop where system-generated aggregated indicators, configuration parameters, and simulation results drive subsequent prompt generation and synthetic data refinement. Without this feedback mechanism, the computing system cannot iteratively improve the quality and alignment of synthetic individuals and simulation outputs in response to new configuration information or updated demographic inputs.

Accordingly, there is a need for an improved computer-implemented system that (i) programmatically transforms raw survey and demographic data into a coherent preprocessed data set, (ii) automatically derives structured prompt sentences from machine-readable aggregated indicators, (iii) constrains a generative AI model to generate validated virtual individual information structures consistent with those indicators, (iv) executes scalable simulation processing on such structures to predict election outcomes, and (v) automatically produces explanation information and formatted output information suitable for multiple notification media, thereby improving computational efficiency, data consistency, and overall system usability.

The specific processing by the specific processing unit 290 of the data processing device 12 in Example 1 is realized by the following means.

The present invention provides a server comprising a processor and a memory storing executable instructions that, when executed by the processor, cause the server to acquire survey information and population statistics for each selection region from one or more data sources and store the survey information and the population statistics in a storage structure; to extract the survey information and the population statistics from the storage structure and execute, within a general-purpose program execution environment, a predefined data processing program that performs preprocessing including completion of missing values, removal of abnormal values, normalization of categorical values, and aggregation processing to thereby generate a machine-readable preprocessed data set; to calculate, from the preprocessed data set, aggregated indicators for each selection region including at least an age distribution, a gender ratio, an occupation distribution, and an education level distribution, and to automatically construct, based on the aggregated indicators, a prompt sentence that defines generation conditions and an output format for virtual individual information structures; to supply the prompt sentence to a generative AI model via an application programming interface so as to cause the generative AI model to generate a plurality of virtual individual information structures, and to parse and validate, in an automated manner, attribute values of the virtual individual information structures against preset constraint conditions and value ranges, discarding or correcting nonconforming virtual individual information structures and registering verified virtual individual information structures in the storage structure; to apply, to the registered virtual individual information structures, a prediction model implemented using at least one of a statistical estimation algorithm and a machine learning algorithm to compute, for each virtual individual information structure, a preference probability for each candidate, and to execute a simulation process that performs mock voting calculations a plurality of times based on the preference probabilities to thereby generate an election prediction result including at least a vote share, an elected candidate, and a reliability indicator for each selection region; and to generate, based on the election prediction result and configuration information specifying, for each notification target, at least one of an output format, a granularity, and explanatory content, a further prompt sentence that defines analysis processing content and an output format for explanation information and formatted output information, and to input the further prompt sentence to the generative AI model so as to cause the generative AI model to generate the explanation information and the formatted output information in a format usable by at least one of a print notification medium, a video notification medium, and a communication notification medium. This enables an integrated, computer-implemented pipeline that automatically converts heterogeneous raw data into validated, demographically consistent virtual individual information structures, executes scalable and repeatable election simulations using such structures, and produces media-specific explanatory and formatted outputs with reduced manual intervention, improved computational efficiency, enhanced data consistency, and better adaptability to diverse output channels.

The term “processor” refers to a hardware computing element, such as a central processing unit or an equivalent processing circuitry, that executes machine-readable instructions to perform data processing operations described in the present disclosure.

The term “storage structure” refers to any logical or physical data storage arrangement, including but not limited to databases, data tables, files, or in-memory data structures, that is configured to store, retrieve, and update information used by the system.

The term “survey information” refers to data representing responses collected from subjects via questionnaires or similar instruments, the data including at least attributes of the subjects and their stated preferences or opinions related to an election.

The term “population statistics” refers to aggregated demographic data describing characteristics of a population in a selection region, including at least distributions of age, gender, occupation, and education level.

The term “selection region” refers to a geographically or administratively defined area, such as an electoral district or sub-district, for which election outcomes are to be predicted.

The term “preprocessed data set” refers to a collection of data records that has been transformed from raw survey information and population statistics through operations including missing-value completion, abnormal-value removal, categorical-value normalization, and aggregation, such that the data records are suitable for subsequent analysis and generation processing.

The term “missing values” refers to data entries in a data record where a required attribute is absent, null, or otherwise not specified.

The term “abnormal values” refers to data entries in a data record that fall outside of predefined valid ranges or violate predefined logical constraints, indicating potential errors or inconsistencies.

The term “categorical values” refers to attribute values representing membership in discrete categories, such as gender, occupation type, or education level, that are typically encoded as labels or codes rather than continuous numeric quantities.

The term “aggregation processing” refers to data processing operations that compute summary indicators, such as counts, ratios, or distributions, from multiple data records grouped by a specified key, such as a selection region.

The term “aggregated indicators” refers to numerical or categorical summaries derived from multiple data records for a selection region, including at least age distribution, gender ratio, occupation distribution, and education level distribution.

The term “prompt sentence” refers to a machine-readable text string that specifies instructions, constraints, and desired output formats to be supplied as input to a generative AI model in order to control the content and structure of model-generated outputs.

The term “generative AI model” refers to an artificial intelligence model configured to generate new data, such as text or structured information, in response to input conditions or prompt sentences, using learned statistical relationships from training data.

The term “virtual individual information structure” refers to a data structure representing a synthetic individual, the data structure including one or more attributes such as age, gender, occupation, and education level, and being generated by a generative AI model based on specified conditions.

The term “generation conditions” refers to parameters, constraints, and attribute distributions that define how a generative AI model should generate virtual individual information structures, including at least target counts, attribute ranges, and consistency with aggregated indicators.

The term “output format” refers to a specification of how generated data should be structured and encoded, such as a JSON representation, a line-delimited text format, or a table-like structure suitable for further processing.

The term “constraint conditions” refers to rules that define permissible values or combinations of values for attributes in a virtual individual information structure, such as minimum and maximum ages or allowed occupation categories.

The term “prediction model” refers to a computational model, implemented using a statistical estimation algorithm or a machine learning algorithm, configured to compute, from input attributes of a virtual individual information structure, a probability distribution over candidate choices or an equivalent measure of candidate preference.

The term “statistical estimation algorithm” refers to a mathematical procedure, such as regression analysis or probabilistic modeling, that estimates parameters or probabilities based on observed data.

The term “machine learning algorithm” refers to a computational method, such as a classification or regression technique, that learns patterns from training data to make predictions or inferences on new data.

The term “preference probability” refers to a numerical value representing a likelihood that a virtual individual associated with a virtual individual information structure will select a particular candidate in an election.

The term “mock voting calculation” refers to a simulated election computation in which candidate choices are assigned to virtual individual information structures based on preference probabilities, in order to approximate an aggregate election outcome.

The term “election result” refers to an outcome of a simulated or actual election, including at least an indication of vote share for each candidate and an identification of an elected candidate in a selection region.

The term “vote share” refers to a numerical measure indicating a proportion of votes assigned to a candidate relative to the total number of votes in a selection region.

The term “reliability indicator” refers to a metric representing confidence or stability of a predicted election result, such as a variance of simulated outcomes or a confidence interval.

The term “configuration information” refers to data specifying control parameters for output generation, including at least an output format, a level of detail (granularity), and desired explanatory content for different notification targets.

The term “explanation information” refers to descriptive text or equivalent content that explains, interprets, or summarizes the election prediction result and underlying indicators in a human-understandable manner.

The term “formatted output information” refers to election prediction data that has been arranged and encoded according to a specified output format suitable for direct use by an external system or media channel.

The term “notification target” refers to a recipient category or channel, such as a nationwide medium, a regional medium, or a video-based medium, for which a specific output format and explanatory style are intended.

The term “print notification medium” refers to a medium that provides information in printed or print-like form, such as newspapers, magazines, or printed reports.

The term “video notification medium” refers to a medium that conveys information primarily through video content, such as television broadcasts or video streaming platforms.

The term “communication notification medium” refers to a medium that delivers information via electronic communication networks, such as web services, mobile applications, or network-based data feeds.

In one embodiment, the invention is implemented by cooperation of a server, one or more terminals, and one or more users. The server includes at least one processor, a main memory, a persistent storage unit, and a network interface. The terminal includes a processor, a memory, a display device, an input device, and a communication interface. The user operates the terminal to interact with the server, to configure the system, and to review prediction results.

The user operates the terminal to collect original survey information and population statistics.

The user accesses a network-based survey platform to design questionnaires, distribute them to respondents in different selection regions, and download the collected responses as comma-separated value (CSV) files. The user accesses an electronic statistics portal provided by a public organization to obtain population statistics for each selection region, also as CSV files. The user stores these files in a designated directory on the terminal.

The terminal establishes a data connection to a relational database management system. In one example, the terminal connects to a relational database engine such as a general-purpose SQL database engine running on the server. The terminal transmits SQL commands to create database tables for storing survey information and population statistics. The terminal then uses built-in bulk-load functions of the database engine to import the CSV files into the corresponding tables.

This database-centric storage structure reduces redundancy and allows the server to perform set-based operations efficiently, improving cache locality and minimizing repeated parsing of raw text files.

The server connects to the relational database using a database driver suitable for the specific database engine. The server executes SQL queries to retrieve survey information and population statistics for each selection region and loads the query results into memory-resident data structures. In one embodiment, the server uses a general-purpose program execution environment such as a scripting language runtime with a data analysis library to represent the data as table-like in-memory objects. The server applies a series of deterministic, ordered preprocessing operations to these in-memory objects, including missing-value completion, abnormal-value removal, categorical-value normalization, and aggregation.

The server uses a predefined rule set for missing-value completion, for example, filling a missing age value with a median age computed per selection region, or filling a missing occupation with a mode occupation within a demographic subgroup. The server detects abnormal values by comparing attribute values against stored numeric bounds, such as rejecting ages below a legal voting age threshold or above an upper bound, and by using statistical criteria, such as standard deviation thresholds for income. The server encodes categorical values using mapping tables that convert free-text entries into normalized category codes. This normalization allows the system to construct fixed-length feature vectors for downstream models and avoids inconsistent category representations that would otherwise degrade prediction accuracy.

The server aggregates the preprocessed records per selection region to compute aggregated indicators, such as age distribution histograms, gender ratios, occupation distributions, and education level distributions. The server stores these aggregated indicators in a dedicated data structure that associates each selection region with a compact vector of demographic statistics.

This structured representation is used both to define constraints for synthetic generation and to parameterize simulation models, resulting in consistent use of demographic information across different processing stages.

The server constructs a prompt sentence to be supplied to a generative AI model. The server converts the aggregated indicators into natural-language descriptions using template-based rules.

For example, when the aggregated statistics indicate that 35 percent of individuals are aged 20-29 and 30 percent are aged 30-39, the server generates text describing that age structure. The server integrates such descriptions with instructions regarding the number of virtual entities to generate, the attributes to include, and the desired output formatting. In one example, the server generates a prompt sentence of the following form:

“Generate 50,000 individual information objects representing voters in Selection Region A.

In this region, approximately 35 percent of the population are aged 20 to 29, 30 percent are aged 30 to 39, and the remaining population is distributed mainly between 40 and 59 years old.

The gender ratio is approximately equal, and about 40 percent of the population are employed in the service industry, 30 percent in office work, and 30 percent in other occupations.

For each individual information object, provide the following fields: age, gender, occupation category, education level, and income bracket.

Ensure that the generated population as a whole matches the described demographic profile.”

The server transmits this prompt sentence to a generative AI model via a network-accessible application programming interface. In one embodiment, the generative AI model is a transformer-based neural network configured for text generation. The model includes an encoder-decoder architecture with multiple attention layers, layer normalization components, and feed-forward sublayers. The model has been trained on large-scale textual data and fine-tuned on structured persona descriptions and demographic narratives. During fine-tuning, the model minimizes a cross-entropy loss between predicted tokens and ground-truth tokens, and the model parameters are updated using gradient-based optimization such as stochastic gradient descent or an adaptive variant. The server may store or reference training metadata, such as vocabulary size, embedding dimensionality, number of layers, and maximum sequence length, to ensure compatibility between prompt sentence structure and model capacity.

The server configures the generative AI model call with parameters such as a temperature value to control randomness, a maximum token count to bound response length, and a stop condition to delimit each virtual individual information structure. The server receives the generated text response and parses it into individual records. The server uses deterministic parsing logic, such as detecting line separators and specific field label markers, to separate each generated object.

The server then applies a validation routine, implemented as a sequence of predicate checks, to ensure that attribute values for age, gender, occupation category, and other fields satisfy the constraint conditions derived from the aggregated indicators and from legal or logical rules.

The server discards any virtual individual information structure that violates constraint conditions or corrects certain values by snapping them to nearest valid categories. For instance, if the generative AI model outputs an occupation not contained in the allowed category list, the server maps this occupation to the nearest category using a similarity mapping or a predefined fallback rule. The server stores the validated virtual individual information structures in the relational database in a dedicated table. By performing validation and correction after generation, the system converts unstructured model outputs into consistent, machine-usable data structures while enforcing demographic constraints, thereby reducing noise and improving the robustness of subsequent simulations.

The server builds a prediction model that consumes the virtual individual information structures as input features. In one embodiment, the server employs a supervised machine learning algorithm such as logistic regression, gradient-boosted decision trees, or a feed-forward neural network. The server extracts features from each virtual individual information structure by converting categorical attributes into one-hot encodings and scaling numerical attributes into normalized ranges. The server loads model parameters that have been previously trained on historical labeled data where respondents' candidate choices are known. The model maps the feature vector of each virtual individual to a probability distribution over candidates, using, for example, a softmax output layer in the case of a neural network.

The server computes, for each virtual individual, a preference probability for each candidate by evaluating the prediction model. The server simulates an election by performing mock voting calculations. The server either samples candidate choices according to the computed probabilities, repeating the process multiple times to approximate a distribution of outcomes, or directly aggregates probability values as expected vote shares. By executing the simulation in a vectorized fashion over large arrays of virtual individuals, the server leverages hardware acceleration and efficient memory access patterns, which significantly reduces computation time compared to record-by-record simulation.

The server aggregates the simulation results to compute, for each selection region, vote shares, an elected candidate, and reliability indicators such as variance of vote shares across simulation runs or confidence intervals. These aggregated simulation outputs are stored in a structured form linked to the corresponding selection region and simulation configuration. This data structure allows the server to compare multiple simulation scenarios and to track the sensitivity of outcomes to changes in demographic assumptions or model parameters.

The server constructs a further prompt sentence to generate explanation information and formatted output information for one or more notification targets. The server uses rule-based templates that incorporate the computed vote shares and reliability indicators. For example, the server generates a prompt sentence such as:

“Based on the simulated voting behavior of 50,000 virtual individuals that match the demographic profile of Selection Region A, the predicted vote share is 48 percent for Candidate X, 35 percent for Candidate Y, and 17 percent for Candidate Z.

Explain these results in clear language suitable for a general audience, highlighting which demographic groups are most associated with each candidate.

Then, provide the results in a structured tabular description that can be used for presentation in printed media and on a broadcast graphic.

Include comments on the reliability of the prediction and any notable uncertainties.”

The server supplies this further prompt sentence to the generative AI model. The model generates explanatory text and tabular-style descriptions. The server parses the model output and maps it into data formats suitable for external systems, such as markup documents for printing, text overlays for video, or structured text for web publication. By using prompt sentences derived from machine-readable simulation results and configuration information, the system ensures that explanatory content is tightly coupled to the underlying numerical predictions and tailored to the intended notification medium.

The terminal retrieves the explanation information and formatted output information from the server. The terminal displays the content to the user in an interactive interface. The user can inspect the predicted election results, the explanatory narrative, and the reliability indicators. The user may request alternative scenarios by altering configuration information, such as adjusting turnout assumptions, modifying the number of synthetic individuals, or selecting different feature sets for the prediction model. The terminal sends these configuration changes back to the server, and the server recomputes aggregated indicators, regenerates prompt sentences, regenerates virtual individuals, and reruns the simulation accordingly. This feedback loop allows the computing system to adapt quickly to new assumptions and to refine predictions without manually rewriting large portions of code or prompt text.

The server improves computer technology in several concrete ways. By defining specific data structures for survey information, population statistics, aggregated indicators, virtual individual information structures, and simulation outputs, the server reduces redundant conversions between unstructured text and structured data, resulting in lower memory overhead and fewer parsing errors. By automatically deriving prompt sentences from aggregated indicators, the server constrains the behavior of the generative AI model and reduces the need for manual prompt engineering, which leads to more consistent outputs and decreased human intervention.

The server coordinates preprocessing, generative modeling, validation, simulation, and output formatting within an integrated pipeline executed in the general-purpose program execution environment and database engine. This integration minimizes unnecessary data transfers, reduces disk I/O, and allows reuse of intermediate results across simulation runs. For example, once virtual individual information structures have been generated and validated for a selection region, the server can rerun simulations with different prediction model parameters without regenerating the synthetic population, thereby improving computational efficiency.

The server employs non-conventional processing rules that differ from human manual forecasting practices. For instance, the server enforces quantitative demographic constraints on synthetic individuals by matching generated attribute distributions to aggregated indicators within specified tolerances, and the server automatically rejects or corrects records that deviate from those constraints. The server also uses multi-stage validation, including both rule-based checks and statistical distribution checks, to ensure that generated populations remain stable and representative. These automated, machine-executed rules allow the system to maintain data quality at scales that are impractical for human operators.

The server can employ different generative AI model configurations and training methods as alternative embodiments. In one variant, the server uses a sequence-to-sequence transformer architecture trained with teacher forcing on paired demographic descriptions and persona lists, using a token-level cross-entropy loss. In another variant, the server uses a conditional variational autoencoder that generates structured attribute vectors for virtual individuals conditioned on aggregated indicators, with a reconstruction loss combined with a Kullback-Leibler divergence term. The server may also employ different error functions, such as mean-squared error over attribute distributions or Earth mover's distance between generated and target demographic histograms, to fine-tune the generative AI model toward better alignment with demographic constraints.

The server may apply data augmentation techniques to improve robustness. For example, the server can automatically generate multiple paraphrased versions of prompt sentences by varying wording and sentence structure while preserving constraints, and can use these variants during fine-tuning of the generative AI model. This augmentation reduces overfitting of the model to a specific prompt pattern and improves generalization to newly generated prompt sentences.

The server may implement different prediction model architectures as alternative embodiments.

In one example, the server uses a multi-layer perceptron with rectified linear unit activations, trained by minimizing a categorical cross-entropy loss between predicted candidate probabilities and observed choices. In another example, the server uses a gradient-boosted tree ensemble that optimizes a logistic loss and automatically selects important features, leading to improved performance on tabular demographic data. The server stores model parameters in the storage structure and supports versioning of models to track accuracy over time.

The server can be deployed on various hardware configurations, including a single physical machine or a cluster of machines. In a clustered configuration, the server distributes generative AI model calls and simulation computations across multiple nodes, using distributed processing frameworks to parallelize operations. This scalability allows the system to handle many selection regions and large synthetic populations in parallel, substantially reducing total computation time.

The system as a whole provides technical effects distinct from mere automation of human tasks.

The server automatically constructs precise, demographically constrained synthetic populations through machine-reading of aggregated indicators and rule-based prompt derivation, which is not feasible by manual trial-and-error prompt editing at scale. The server enforces machine-level constraint checking and distribution matching that systematically controls variance and error in synthetic data. The integration of validated synthetic populations with high-throughput simulation models produces more accurate, repeatable, and explainable election predictions.

These improvements in data management, algorithmic consistency, and computational efficiency directly enhance the functioning of the computer system itself, yielding faster processing, reduced error rates, and optimized use of storage and network resources, and thereby satisfy technical requirements for implementation under applicable patent guidelines.

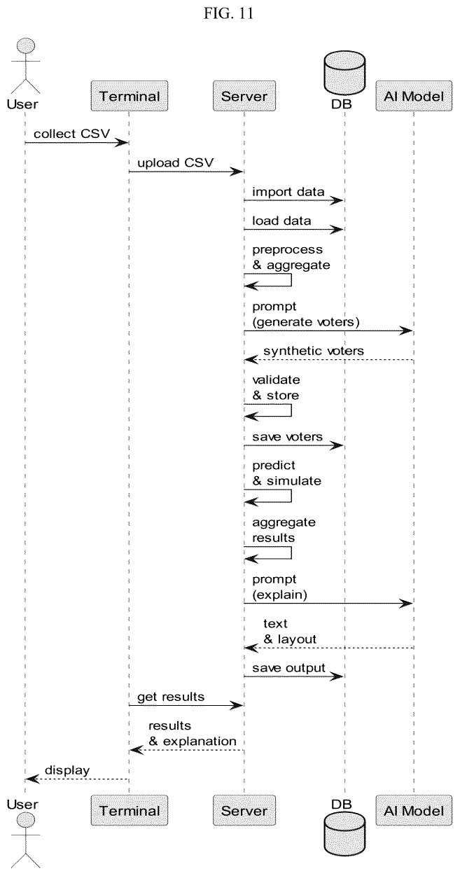

The following describes the processing flow using FIG. 11.

### Step 1

The user operates the terminal to collect original data.

The user designs questionnaires on a survey platform, distributes links to respondents in each selection region, and downloads survey responses as CSV files.

The user accesses an electronic statistics portal to download population statistics per selection region as CSV files.

Input: raw responses from respondents and demographic statistics from external providers.

Output: survey CSV files and demographic CSV files stored in a directory on the terminal.

### Step 2

The terminal connects to a relational database engine running on the server or on the terminal.

The terminal executes SQL commands to create tables for survey information and population statistics, including appropriate columns and data types.

The terminal invokes bulk-import functions of the database engine to load the survey CSV files and demographic CSV files into the created tables.

The terminal checks record counts by executing SQL count queries to verify successful import.

Input: CSV files containing survey information and population statistics.

Output: structured survey records and demographic records stored in database tables.

### Step 3

The server establishes a database connection using a database driver.

The server executes SQL queries to retrieve survey records and demographic records for each selection region and loads them into in-memory table-like objects.

The server logs extraction metadata such as region identifiers, record counts, and timestamps.

Input: survey records and demographic records stored in database tables.

Output: in-memory data sets representing survey information and population statistics per selection region.

### Step 4

The server performs preprocessing of the in-memory data sets in a general-purpose program execution environment.

The server detects missing values in key attributes such as age, gender, occupation, and education level, and fills them using rules such as median age per region or most frequent occupation per subgroup.

The server identifies abnormal values by applying numeric bounds and statistical thresholds, and removes or corrects records with impossible or inconsistent values.

The server normalizes categorical values by mapping free-text entries to standardized category codes using predefined mapping tables.

Input: raw in-memory data sets containing uncleaned survey and demographic records.

Output: cleaned data sets with missing values completed, abnormal values handled, and categorical values normalized.

### Step 5

The server aggregates the cleaned data sets per selection region.

The server calculates distributions such as age histograms, gender ratios, occupation distributions, and education level distributions.

The server stores these aggregated indicators in a structured format that associates each selection region with its demographic vector.

Input: cleaned data sets for all individuals or groups in each selection region.

Output: aggregated demographic indicators per selection region.

### Step 6

The server generates a prompt sentence for each selection region based on the aggregated demographic indicators.

The server uses template rules to convert numeric distributions into natural-language descriptions of age structure, gender ratio, occupation mix, and education composition.

The server appends instructions specifying the number of virtual individuals to generate, required attributes, and overall constraints on demographic consistency.

For example, the server may generate a prompt sentence such as:

“Generate 50,000 individual information objects representing voters in Selection Region A. In this region, approximately 35 percent of the population are aged 20 to 29, 30 percent are aged 30 to 39, and the remaining population are mainly aged 40 to 59. The gender ratio is approximately equal, and about 40 percent of the population work in the service industry, 30 percent in office work, and 30 percent in other occupations. For each individual information object, provide age, gender, occupation category, education level, and income bracket. Ensure that the overall population of generated individuals matches the described demographic profile.”

Input: aggregated demographic indicators per selection region.

Output: prompt sentences describing generation conditions and attribute requirements for virtual individuals.

### Step 7

The server sends each prompt sentence to a generative AI model through an application programming interface.

The server configures API parameters such as maximum token length, randomness control, and stopping criteria, and transmits the prompt sentence as part of a request payload.

The server receives a text response that contains multiple descriptions of virtual individuals, each including specified attributes.

Input: prompt sentences that define the number, attributes, and constraints for virtual individuals.

Output: raw generated text containing candidate virtual individual information structures.

### Step 8

The server parses the raw generated text into discrete virtual individual information structures.

The server identifies delimiters or line breaks separating each individual, extracts attribute values by matching labels or positions, and constructs a structured representation for each individual.

The server validates each structure against constraint conditions derived from the aggregated indicators and legal or logical rules, such as valid age ranges and allowed occupation categories.

The server discards or corrects structures that fail validation and registers the valid structures in a database table dedicated to virtual individuals.

Input: raw generated text output from the generative AI model.

Output: validated and structured virtual individual information records stored in the database.

### Step 9

The server prepares input features for a prediction model from the virtual individual information records.

The server converts categorical attributes to numerical encodings, normalizes numerical attributes, and constructs feature vectors for each virtual individual.

The server loads parameters of a trained prediction model, such as a logistic regression model, a tree-based model, or a neural network, from storage.

Input: validated virtual individual information records for a selection region.

Output: feature vectors ready for prediction and a loaded prediction model.

### Step 10

The server applies the prediction model to the feature vectors to calculate preference probabilities.

The server computes, for each virtual individual, a probability value for each candidate, and stores the resulting probability distributions in memory or in an intermediate table.

Input: feature vectors derived from virtual individual information records.

Output: preference probabilities per candidate for each virtual individual.

### Step 11

The server performs mock voting simulations using the preference probabilities.

The server either samples candidate choices for each virtual individual based on probability distributions or aggregates probabilities across individuals to estimate expected vote shares.

The server repeats the simulation multiple times if sampling is used, and aggregates results to compute statistical measures such as mean vote share and variance.

Input: preference probabilities per candidate for each virtual individual.

Output: simulated election outcomes including vote shares and variability for each candidate in each selection region.

### Step 12

The server aggregates simulated outcomes per selection region.

The server determines the candidate with the highest vote share as the predicted winner for each region.

The server calculates reliability indicators such as standard deviation of vote shares, confidence intervals, or other stability measures from repeated simulations.

Input: simulated election outcomes from multiple simulation runs.

Output: predicted vote shares, predicted winning candidates, and reliability indicators per selection region.

### Step 13

The server generates a further prompt sentence for explanation and formatting based on the prediction results and configuration information.

The server composes a text that summarizes key numerical results and requests narrative explanation and structured presentation suitable for specific media.

For example, the server may generate a prompt sentence such as:

“Based on a simulation using 50,000 virtual voters that match the demographic profile of Selection Region A, the predicted vote share is 48 percent for Candidate X, 35 percent for Candidate Y, and 17 percent for Candidate Z. Write an explanation of these results suitable for a general audience, describing which demographic groups are most associated with each candidate. Then provide a concise tabular description of the vote shares and an indication of the reliability of the prediction for use in printed and televised reports.”

Input: predicted vote shares, winning candidates, reliability indicators, and media configuration information.

Output: prompt sentences requesting explanatory text and formatted output descriptions.

### Step 14

The server sends the further prompt sentences to the generative AI model via the same or a similar application programming interface.

The server receives responses containing explanatory narratives and formatted descriptions aligned with the requested structure.

The server parses the responses, separating narrative text from structured or semi-structured descriptions, and converts them into data fields suitable for downstream use.

Input: further prompt sentences describing explanation and formatting requirements.

Output: explanation information and formatted output information representing the prediction results.

### Step 15

The server stores the explanation information and formatted output information in the database or another storage structure associated with each selection region.

The server exposes interfaces for external systems and terminals to retrieve this information, such as web service endpoints or file export functions.

Input: explanation information and formatted output information generated from the generative AI model.

Output: persisted explanation and formatted data available for retrieval and distribution.

### Step 16

The terminal requests prediction results and associated explanatory content from the server.

The terminal receives the data via a communication interface and renders it on a display device as tables, charts, and text summaries.

The user reviews the displayed information, evaluates the results, and optionally adjusts configuration parameters such as turnout assumptions or model selection.

Input: prediction results, explanation information, and formatted output information obtained from the server.

Output: visualized content for the user and, when adjustments are made, updated configuration settings sent back to the server.

### Application Example 1

Description follows regarding a flow of the specific processing in an Application Example 1.

The units of the system described below are implemented by the data processing device 12 and the smart device 14. The data processing device 12 is called a “server” and the smart device 14 is called a “terminal”.

Conventional computer-implemented techniques for election prediction and advertising campaign planning suffer from several technical limitations at the data processing and modeling layers. First, when only small-scale preliminary surveys are available, typical systems directly extrapolate from sparse records stored in databases, leading to unstable statistical estimates and high variance in predictions. Such systems usually operate on raw tabular records without systematically constructing a large, structured population model in memory, which limits the ability of the processor to execute scalable simulations and degrades cache locality and overall computational efficiency.

Second, traditional audience segmentation for advertising is often performed by static rules or simple filtering on database fields. These approaches do not effectively exploit high-dimensional demographic distributions, and they do not integrate with adaptive natural language generation or evaluation. As a result, the processor must repeatedly perform ad-hoc query and formatting operations for each segment, which increases processing latency and leads to fragmented, non-reusable computation paths.

Third, existing uses of generative AI models in marketing or prediction tasks are typically limited to manual, unstructured prompts authored by human operators. The prompts are not systematically derived from machine-readable demographic aggregates or simulation results.

Consequently, the processor cannot automatically generate consistent, machine-optimized prompt sentences that tightly couple structured demographic summaries with evaluation tasks.

This leads to non-deterministic behavior, difficulty in reproducing results, and extensive manual trial-and-error at the user interface.

Fourth, conventional systems do not provide an integrated computational loop in which (i) synthetic population objects are generated from small-scale and demographic data, (ii) large-scale simulations are executed on this synthetic population to produce probabilistic prediction outputs, and (iii) those outputs are automatically fused with generative AI model responses to compute quantitative effectiveness indices for multiple advertising messages.

Without such an integrated loop, the processor must orchestrate separate subsystems with incompatible data formats, causing redundant data transformations, increased memory transfers, and delays in delivering feedback to user terminals.

Thus, there is a need for a computer-implemented technique that improves the way a processor acquires and represents demographic information as personality objects, simulates large-scale survey behavior, automatically constructs structured prompt sentences for a generative AI model, and computes and returns ranked, machine-interpretable metrics for election prediction and advertising effectiveness. Such a technique should improve the technical efficiency, scalability, and reproducibility of the underlying data processing pipeline and should reduce the manual burden on user terminals in preparing and evaluating campaign strategies.

The specific processing by the specific processing unit 290 of the data processing device 12 in Application Example 1 is realized by the following means.

The present invention provides a server comprising a processor and a memory configured to store instructions, the processor being configured to execute the instructions to acquire, from a storage unit, small-scale preliminary survey data and demographic data for each region, compute attribute distributions from the demographic data, and generate, in accordance with the attribute distributions, a plurality of personality objects representing virtual individuals as structured records; to segment, based on attribute conditions, the plurality of personality objects to extract one or more groups, to aggregate attributes of each group to form group information, and to generate, for each group, a machine-constructed prompt sentence including the group information, at least one of an advertising message or a survey question, and an instruction portion specifying an evaluation procedure and an output format, and to input the prompt sentence to a generative AI model and obtain response information including evaluation information or improvement proposals; and to compute, based on the response information and on aggregated statistics of the personality objects, at least one of a predicted winning candidate or an effectiveness index for an advertising campaign, to rank a plurality of advertising messages according to the effectiveness index, and to transmit result information including the evaluation information, the improvement proposals, and the ranked messages to a terminal device for display to a user. This enables the server to transform sparse survey and demographic records into a synthetic, cache-efficient population model, to perform large-scale simulations and AI-assisted evaluations in a unified processing pipeline, and to automatically generate consistent, structured prompts and ranked effectiveness metrics, thereby improving the technical performance, scalability, and reproducibility of computer-implemented election prediction and advertising strategy optimization.

The term “processor” refers to a hardware computation unit, such as a central processing unit or a graphics processing unit, that executes machine-readable instructions to perform arithmetic operations, logical operations, data transfer operations, and control operations.

The term “memory” refers to a hardware storage unit, such as a volatile memory device or a non-volatile memory device, that stores machine-readable instructions, data structures, intermediate results, and configuration information used by the processor.

The term “storage unit” refers to a hardware data storage resource, such as a magnetic storage device, an optical storage device, or a solid-state storage device, that persistently stores survey data, demographic data, prediction results, and log information.

The term “small-scale preliminary survey data” refers to digital records representing responses obtained from a relatively limited number of respondents prior to a main survey, each record including at least one of an answer to a question, a respondent identifier, or a region identifier.

The term “demographic data” refers to structured information describing characteristics of a population, such as age, gender, occupation type, education level, income level, or geographic region, encoded in a machine-readable format.

The term “attribute distribution” refers to a representation, such as a frequency table or a probability distribution, indicating how often particular attribute values or combinations of attribute values occur within a population or a subset of a population.

The term “personality object” refers to a data structure, such as a record or an object instance, that represents a virtual individual and includes one or more attributes, such as age, gender, occupation type, education level, region identifier, or preference indicator.

The term “virtual individual” refers to a simulated entity that does not correspond directly to a real person, but that is defined by a set of attributes and is used for computational modeling, simulation, or analysis.

The term “group of personality objects” refers to a subset of the plurality of personality objects selected according to one or more conditions, such as an age range, a gender, an occupation type, an education level, or a region identifier.

The term “group information” refers to aggregated data derived from a group of personality objects, including at least one of a count, a distribution of attributes, an average value, a variance, or a summary statistic that characterizes the group.

The term “attribute conditions” refers to one or more constraints or filters applied to attributes of personality objects, such as a specified age interval, a specified gender, a specified occupation type, a specified education level, or a specified region.

The term “prompt sentence” refers to a machine-generated or machine-formatted textual input, including instructions, descriptions, and content, that is provided to a generative AI model to cause the generative AI model to produce an output.

The term “generative AI model” refers to a parameterized computational model, such as a neural network or a language model, that generates output data, such as natural language text, based on an input sequence, including a prompt sentence.

The term “response information” refers to data produced by the generative AI model in response to a prompt sentence, including at least one of an evaluation result, a numerical score, a classification result, a natural language explanation, or a candidate message.

The term “evaluation information” refers to a part of the response information that expresses an assessment of a given input, such as an advertising message or a survey question, and may include a numerical rating, a qualitative judgment, or a comparative analysis.

The term “improvement proposal” refers to a part of the response information that includes at least one suggested modification, correction, or alternative to an input message, such as a revised advertising text, a different wording, or a new message variant.

The term “election result” refers to an outcome of a voting process, such as a predicted or actual number of votes obtained by each candidate, a probability of winning, or an identification of a winning candidate.

The term “advertising effect” refers to an influence of an advertising message on a target group, including at least one of an expected engagement level, a conversion likelihood, a recall rate, or a change in preference.

The term “effectiveness index” refers to a quantitative measure derived from evaluation information and other metrics that indicates how effective an advertising message or campaign is expected to be for a specific target group.

The term “advertising campaign” refers to a set of coordinated advertising activities, including multiple advertising messages, channels, and schedules, that are designed to achieve a marketing objective.

The term “advertising message” refers to a textual content unit, such as a slogan, a description, or a call to action, intended to promote a product, a service, or a concept to a target group.

The term “information medium” refers to a distribution channel or platform, such as a print medium, a broadcast medium, or a digital communication medium, through which prediction results or advertising messages are provided to recipients.

The term “terminal device” refers to a user-operated computing apparatus, such as a personal computer, a tablet device, or a mobile communication device, that communicates with the server, sends input data, and receives and displays output data.

The term “target conditions” refers to user-specified constraints that define a target group, such as demographic parameters, region parameters, interest parameters, or behavioral parameters.

The term “target group” refers to a set of real or virtual individuals that satisfy the target conditions and are intended recipients of an advertising message or subject of an analysis.

The term “result information” refers to data transmitted from the server to the terminal device, including at least one of evaluation information, improvement proposals, ranked messages, prediction results, or visualization-ready metrics.

The term “simulation process” refers to a computational procedure in which the processor applies models or algorithms to personality objects to emulate responses or behaviors that would be observed in a large-scale survey or campaign.

The term “probabilistic model” refers to a mathematical model, such as a logistic regression model, a Bayesian model, or another stochastic model, that outputs probabilities or probability distributions based on input features.

The term “statistical model” refers to a computational model that uses statistical relationships between variables to estimate parameters, predict outcomes, or infer distributions from data.

The term “support probability” refers to a likelihood value, computed by a probabilistic model or a statistical model, that a particular candidate or option will be supported by a given personality object or group of personality objects.

The term “instruction portion” refers to a part of the prompt sentence that specifies how the generative AI model should process the input, including indications of evaluation criteria, required output format, number of variants, or degree of detail.

The term “candidate message” refers to an alternative advertising message or text variant generated by the generative AI model for evaluation or selection.

The term “ranked messages” refers to a set of advertising messages that have been ordered according to a criterion, such as an effectiveness index, from most effective to least effective.

The term “user” refers to a human operator who interacts with the terminal device to specify target conditions, provide advertising messages, and review prediction or evaluation results.

In one embodiment, a server, a terminal, and a user cooperate to implement the system.

The server includes at least one hardware processor, a main memory, a non-volatile storage device such as a solid-state drive, and a network interface. The server executes a general-purpose operating system such as a server-class operating system and runs application software including a web application framework, a database management system, and a machine learning runtime environment. The server is connected via a communication network to one or more terminals.

The terminal includes a processor, a memory, a display, and user input devices such as a touchscreen, a keyboard, or a pointing device, and executes a web browser or native application that presents a user interface for specifying target conditions, entering advertising messages, and viewing results.

The server stores small-scale preliminary survey data and demographic data in a persistent storage unit. The server uses a relational database management system, such as a generic relational database, to store tabular records, and may additionally store large demographic datasets as comma-separated files on the storage device. The server reads the data into main memory using a data analysis library such as a generic data-frame library. The server cleans and normalizes the data by applying deterministic algorithms that map raw attribute values into categorical codes, convert string labels into numeric identifiers, and handle missing values using predefined rules such as mean imputation for numerical attributes or majority-class imputation for categorical attributes.

The server constructs attribute distributions by grouping demographic records by region and by attribute combinations. The server computes frequency counts and converts these to probability distributions using arithmetic operations performed by the processor. The server stores the resulting distributions in a structured, machine-readable format such as key-value mappings in memory or in a document database. By keeping these distributions as compressed probability tables rather than raw records, the server reduces memory footprint and improves cache locality when later sampling large numbers of virtual individuals. This transforms a sparse data representation into an efficient, simulation-ready representation.

The server generates a large number of personality objects by sampling from the attribute distributions. Each personality object is stored as a record containing fields such as age group, gender, occupation type, education level, and region identifier, and may contain additional inferred attributes such as political engagement scores or media consumption tendencies. The server uses pseudo-random sampling functions that accept the probability distributions as parameters and output attribute values for each virtual individual. The server assigns each personality object a unique identifier and stores the objects in a collection that is indexed by attributes commonly used in queries. This indexing scheme allows the processor to filter and retrieve subsets of personality objects with low latency, even when the collection size reaches hundreds of thousands or millions of entries.

The server uses these personality objects as input to one or more predictive models for simulating large-scale questionnaires. In one embodiment, the server uses a parametric probabilistic model such as a logistic regression model represented by a weight vector and bias parameters. The server encodes each personality object as a feature vector, using one-hot encodings for categorical attributes and normalized values for numerical attributes. The server applies linear algebra operations to compute a predicted probability that the virtual individual supports a given candidate or responds positively to a particular message. The server aggregates these probabilities across all personality objects in a region to produce predicted support distributions and expected vote shares. By running these vectorized operations on batches of personality objects, the server reduces the number of memory fetches and exploits hardware-level parallelism, which results in improved computational throughput compared with naive record-by-record processing.

The server also segments personality objects to build virtual target groups for advertising simulation. The server receives target conditions from the terminal, such as an age range, a gender, an occupation type, and an education level. The server translates these conditions into database queries that filter the personality object collection. The server aggregates the selected subset into group information, including attribute histograms, averages, and derived indicators such as the proportion of individuals who work in a given sector or hold a particular degree. The group information is kept in memory as compact arrays or dictionaries, enabling efficient further processing.

The server uses a generative AI model to evaluate and improve advertising messages for the target group. In one embodiment, the generative AI model is a neural language model implemented as a multi-layer transformer network. The network includes an embedding layer, a sequence of self-attention blocks, and an output layer that produces token probability distributions. The model is trained in advance on large text corpora using a language modeling objective that minimizes a cross-entropy loss between predicted tokens and ground-truth tokens.

During training, the model updates its parameters using stochastic gradient descent or a related optimizer, such as an adaptive learning-rate method. The model accepts as input a sequence of tokens representing a prompt sentence and outputs a sequence representing a completion.

The server constructs the prompt sentence using a non-trivial, algorithmic procedure from machine-readable group information and user-supplied ad text. The server selects a subset of attributes and statistics from the group information, such as age range, gender distribution, prevalent occupation types, and education levels, and converts these into a natural language description. The server then appends the advertising message and explicit instructions specifying how the generative AI model should evaluate or transform the message. For example, the server may generate a prompt sentence of the following form:

“Here is a description of a virtual audience: women aged 30-39, university graduates, currently working in the marketing industry. They are tech-savvy, care about ROI, and are busy professionals. Evaluate the following advertisement message for this audience: ‘Boost your marketing performance with our analytics platform that tracks every campaign in real time.’
1) Provide an effectiveness score from 1 to 10.
2) Explain in 3-4 sentences why the message is or is not effective.
3) Generate three improved versions of the message that would be more persuasive to this audience, each under 40 words.

Output your answer in JSON format with keys: ‘score’, ‘analysis’, and ‘variants’.”

The server then converts this prompt sentence into a token sequence, sends it to the generative AI model via an inference API, and obtains response information. Internally, the generative AI model computes attention weights between tokens, multiplies by learned parameter matrices, applies non-linear activation functions, and generates probabilities for each next token. The response information includes textual content that the server parses according to the requested output structure. The server extracts numerical scores, explanatory text, and candidate revised advertising messages. The server may normalize or rescale the scores and combine them with simulation statistics derived from the personality objects to compute a final effectiveness index per message.

The server, by tying the generative AI model to deterministic group-level statistics and simulation outputs, enforces a structured interaction pattern that differs from conventional free-form prompting. The prompt construction algorithm is rule-based and non-conventional in that it systematically embeds numeric summaries into a controlled natural language template and constrains the expected output format. This allows the server to parse responses reliably and reuse them programmatically. The server thereby reduces manual trial-and-error prompting that would otherwise be performed by a human user at the terminal.

The terminal functions as a thin client that delegates heavy computation to the server. The terminal displays graphical user interface components that are generated or updated based on metadata received from the server. The terminal renders input forms where the user selects demographic ranges via dropdown menus, enters advertising text into a text area, and triggers evaluations via buttons. The terminal sends user selections and text to the server in structured requests. The terminal receives from the server ranked messages, scores, and explanatory texts and displays these as tables, charts, and formatted text. The terminal does not need to understand the internal structure of the personality objects or the generative AI model; instead, the terminal simply renders pre-processed results, which reduces complexity at the client side and network traffic associated with repeatedly fetching raw data.

The user defines campaign scenarios by operating the terminal. The user may, for example, specify “age: 30-39,” “gender: female,” “occupation: marketing,” and “education: university graduate,” and then enter an advertising message that promotes a particular service. The user can then view multiple alternatives generated and evaluated by the server and may iteratively refine the message and targeting criteria. The user does not manually construct detailed prompts for the generative AI model, because the server performs that construction according to predefined templates and rules.

The server improves computer technology in several ways. By converting sparse survey and demographic data into a synthetic population of personality objects with indexed storage, the server enables cache-friendly, batch-oriented numerical processing for simulations. This results in reduced memory bandwidth usage and lower latency when computing predictions compared with directly operating on raw relational tables. By separating group aggregation from individual sampling, the server can re-use group statistics across multiple simulations and prompt generations, further reducing redundant computation.

The server also improves data management by using explicit, typed data structures for personality objects and group information. The server maintains these structures in a layered architecture where raw data, distributions, synthetic objects, and aggregated groups are separated but linked. This structure simplifies consistency checks and facilitates incremental updates when new survey data arrives, without requiring full reprocessing of all data. The technical effect is a more maintainable and scalable data pipeline that can handle increased data volume without linear growth in processing time.

The server further improves the utilization of generative AI models in a way that departs from mere human mimicry. The server applies fixed, machine-executable rules to synthesize prompts, structure outputs, and integrate the outputs into quantitative indices. The generative AI model is thus used as a component in a larger computational graph rather than as a stand-alone text generator. Because the prompts systematically incorporate demographic and simulation results, the responses are more aligned with the underlying data than ad hoc human-authored prompts.

This reduces variance and improves reproducibility of evaluations, which is a technical improvement in the use of neural language models.

In another embodiment, the server uses different generative models or predictive models. The server may employ a neural network based classifier trained with a cross-entropy loss to estimate support probabilities directly from personality object features. The server may also use alternative neural architectures for the generative AI model, such as recurrent neural networks or encoder-decoder models. The underlying method of constructing prompt sentences from group information and parsing structured responses remains applicable regardless of the specific model architecture.

In a further embodiment, the server adapts the selection of prompt templates based on system-level metrics such as response length, parse error rate, or latency. The server may, for example, maintain several template variants and choose among them based on historical performance, using reinforcement signals such as accuracy of downstream ranking or user acceptance of suggested messages. Although the generative AI model parameters remain fixed during inference, the adaptation of templates at the server increases the robustness and effectiveness of the pipeline.

In another embodiment, the server includes a module that minimizes communication load between the server and the terminal. The server pre-computes summary metrics and compact representations of ranking results and sends only these summaries to the terminal, rather than full intermediate data or all personality objects. This reduces network bandwidth consumption and allows the system to function effectively even under constrained network conditions. The server can also cache frequent target configurations and reuse corresponding group information and partially computed results, resulting in faster repeated evaluations.

In still another embodiment, the server uses the same infrastructure to support other types of campaigns or prediction tasks, such as public health messaging or product launch planning. The server may adjust the attributes contained in personality objects or modify the probabilistic models used in simulations, while the overall framework of synthetic population generation, group aggregation, prompt construction, generative AI interaction, and result ranking remains the same. This demonstrates that the described system is not limited to a particular business context but rather improves the underlying computer-based data processing and AI integration mechanism.

By orchestrating structured demographic modeling, probabilistic simulation, rule-based prompt construction, and generative AI evaluation within a single server-controlled pipeline, the system provides a concrete technical solution that achieves faster computations, improved prediction and evaluation accuracy, reduced memory and communication overhead, and reproducible integration of large-scale AI models.

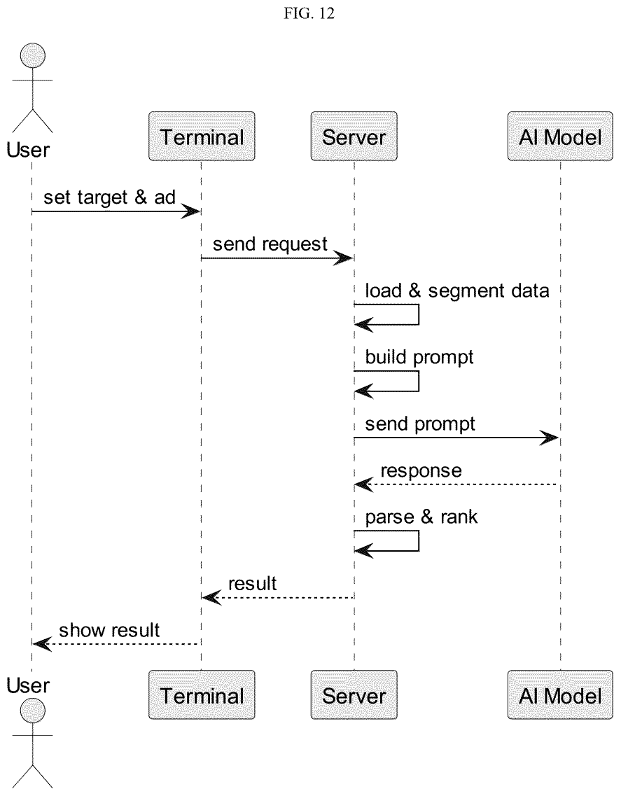

The following describes the processing flow using FIG. 12.

### Step 1

The server acquires raw data. The server receives, as input, small-scale preliminary survey data and demographic data for each region from a storage unit or an external data source. The server reads tables from a database and files from a storage device into main memory. The server outputs a unified in-memory dataset that combines the survey records and the demographic records.

### Step 2

The server preprocesses and normalizes the raw data. The server takes, as input, the unified dataset from Step 1. The server performs data cleaning operations, including removing or imputing missing values, converting textual categories (such as education level and occupation type) into standardized codes, and normalizing formats of region identifiers and age ranges. The server uses deterministic mapping tables to convert string labels to integer codes and applies arithmetic operations to normalize numerical fields. The server outputs a cleaned and normalized dataset suitable for statistical processing.

### Step 3

The server computes attribute distributions. The server takes, as input, the cleaned dataset from Step 2. The server groups the records by region and by attribute combinations such as age group, gender, occupation type, and education level. The server counts the number of records in each group and divides each count by the total number of records in the corresponding region to obtain probability values. The server outputs attribute distribution tables that map attribute combinations to probabilities for each region.

### Step 4

The server generates personality objects. The server takes, as input, the attribute distribution tables from Step 3 and a specified number of virtual individuals per region. The server executes sampling operations using pseudo-random number generation: for each virtual individual, the server selects attribute values according to the probabilities in the distribution tables. The server constructs a personality object as a data structure containing fields such as age group, gender, occupation type, education level, region identifier, and optional scores such as political interest. The server writes these personality objects into an indexed collection in storage and outputs a plurality of personality objects stored in memory and in a database.

### Step 5

The server performs simulation for election prediction. The server takes, as input, the plurality of personality objects from Step 4 and parameters of a probabilistic or statistical model, such as regression coefficients for each candidate. The server encodes the attributes of each personality object into a feature vector and computes, by linear algebra operations and activation functions, a support probability for each candidate for that personality object. The server aggregates these probabilities across all personality objects in each region by summing and normalizing them, thereby computing predicted support distributions and identifying a candidate with the highest expected support. The server outputs predicted vote shares and a predicted winning candidate for each region.

### Step 6

The terminal collects target conditions and advertising content. The terminal takes, as input, user interactions on a graphical user interface. The user selects target conditions such as age range, gender, occupation type, education level, and region via input widgets, and the user enters an advertising message in a text field. The terminal validates the input format, packages the target conditions and advertising message as a structured request, and outputs this request by transmitting it to the server over a communication network.

### Step 7

The server segments personality objects according to target conditions. The server takes, as input, the request from the terminal containing the target conditions and the advertising message, and the stored personality objects from Step 4. The server constructs a query based on the target conditions and retrieves matching personality objects from the database. The server aggregates the retrieved objects by computing counts, proportions of attributes, and summary statistics such as average inferred interest scores. The server outputs group information that characterizes the virtual target group and forwards the advertising message to subsequent processing.

### Step 8

The server constructs a prompt sentence for the generative AI model. The server takes, as input, the group information from Step 7 and the advertising message submitted by the user in Step 6.

The server converts key elements of the group information (including age range, gender, occupation type, education level, and typical preferences) into a natural language description.

The server concatenates this description with the advertising message and explicit instructions describing evaluation criteria, required output format, and number of improved variants. For example, the server generates a prompt sentence such as:

“Here is a description of a virtual audience: women aged 30-39, university graduates, currently working in the marketing industry. They are tech-savvy, care about ROI, and are busy professionals. Evaluate the following advertisement message for this audience: ‘Boost your marketing performance with our analytics platform that tracks every campaign in real time.’
1) Provide an effectiveness score from 1 to 10.
2) Explain in 3-4 sentences why the message is or is not effective.
3) Generate three improved versions of the message that would be more persuasive to this audience, each under 40 words.

Output your answer in JSON format with keys: ‘score’, ‘analysis’, and ‘variants’.”

The server outputs the constructed prompt sentence as a text string.

### Step 9

The server invokes the generative AI model. The server takes, as input, the prompt sentence from Step 8. The server encodes the prompt sentence into tokens, sends the tokens to a generative AI model implemented as a neural network, and initiates an inference operation. The generative AI model internally performs matrix multiplications, attention computations, and non-linear transformations to produce output token probabilities and generates a sequence representing the response. The server receives the generated sequence as response information. The server outputs the raw response text that includes an effectiveness score, analytical explanation, and candidate improved advertising messages.

### Step 10

The server parses and evaluates the response information. The server takes, as input, the raw response text from Step 9 and, if available, simulation statistics from Step 5 and group information from Step 7. The server applies parsing rules to extract structured fields such as numerical scores, analytical paragraphs, and individual candidate messages. The server converts the extracted score fields into numerical values, optionally normalizes or rescales them, and combines them with simulation statistics to compute a final effectiveness index for each candidate message. The server ranks the candidate messages by effectiveness index and generates result information containing the original advertising message, the ranked candidate messages, the associated scores, and explanatory text. The server outputs this result information as a structured response to the terminal.

### Step 11

The terminal presents the results to the user. The terminal takes, as input, the result information from Step 10. The terminal parses the structured response, extracts the ranked messages, scores, and explanations, and renders them on the display. The terminal may show a list of messages ordered by effectiveness, numerical indicators as charts, and textual explanations in readable sections. The terminal outputs a visual representation that the user can inspect and interact with.

### Step 12

The user reviews and refines the campaign strategy. The user takes, as input, the visualized results displayed on the terminal in Step 11. The user compares the original and improved messages, checks the effectiveness indices and explanations, and decides whether to adopt, modify, or discard suggested messages. Based on this evaluation, the user may adjust target conditions, edit the advertising message, and initiate another evaluation cycle via the terminal.

The user outputs new input parameters and text for subsequent processing by the server.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a

Conventional techniques for predicting election outcomes based on opinion surveys suffer from several technical limitations in the way information processing systems handle data generation, data modeling, and simulation execution. Typical systems directly aggregate raw survey answers and demographic records using fixed, rule-based algorithms, and then apply simple statistical models. In such systems, a processor generally treats survey result information and demographic information as static tabular data and executes predetermined aggregation procedures. As a result, the processor is unable to flexibly model complex preference patterns of diverse populations and cannot efficiently reuse or adaptively refine behavioral models across different regions or scenarios.

Moreover, when the processor attempts to simulate voting behavior on a large scale, the processor often must generate and manage a large number of synthetic records using custom code or manual configuration. This requires extensive engineering effort for defining feature sets, weighting factors, and clustering rules, and typically leads to brittle, hand-tuned systems that are difficult to maintain and to port to new regions. The processor also incurs substantial computational overhead when it iteratively recalculates simulation logic every time new survey result information, demographic information, or candidate policy information is introduced.

Further, in many existing systems, the processor does not have an integrated mechanism to transform unstructured natural-language policy descriptions into a format that can be directly used for high-resolution simulation. Candidate policy information is generally reduced to a small set of numeric variables or labels through ad hoc preprocessing. This lossy transformation often discards nuanced semantic relationships between voter preferences and policy content, leading to degraded prediction accuracy. Additionally, there is typically no robust workflow that uses a unified computational model to both generate virtual voter profiles and drive the subsequent simulation of preference behavior.

Another technical problem arises in the interface between prediction engines and information media. Conventional systems frequently generate prediction results in rigid formats that are not easily adaptable for different media channels. The processor usually executes separate formatting routines for each output destination, causing duplication of logic, increased latency, and higher risk of inconsistency among published outputs. When such systems attempt to support complex analytical visualizations, the processor often has to perform additional post-processing steps that are not well integrated with the underlying simulation, further increasing processing time and resource consumption.

Additionally, existing systems rarely exploit generative AI models as programmable co-processors for controlling data generation, normalization, and simulation behavior through machine-interpretable prompt sentences. Without this capability, the processor cannot dynamically synthesize personality data structures from heterogeneous inputs, nor can it flexibly delegate similarity calculations and behavioral inference to a model specialized in natural language and high-dimensional representation learning. Consequently, the overall information processing pipeline remains rigid, fragmented, and computationally inefficient.

In view of the foregoing, there is a need for an improved information processing system in which a processor cooperates with a generative AI model via prompt sentences to (i) generate structured personality data structures representing virtual subjects based on survey result information and demographic information, (ii) normalize and parameterize such data structures for efficient storage and retrieval in relational data storage, (iii) simulate preference behavior by comparing personality attributes with candidate attributes encoded from natural-language descriptions, and (iv) aggregate and format prediction results into reusable analysis result data for multiple information distribution devices. Such a system should technically improve the way a processor manages complex data flows, leverages semantic similarity computations, and generates prediction outputs, thereby enhancing scalability, maintainability, and prediction accuracy in computer-implemented election forecasting and similar large-scale behavioral simulations.

The specific processing by the specific processing unit 290 of the data processing device 12 in Example 2 is realized by the following means.

The present invention provides a server comprising a processor configured to input, to a generative AI model, prompt sentences that cause the generative AI model to generate personality data structures representing virtual subjects on the basis of survey result information and demographic information for each region, to normalize and store the generated personality data structures as structured records in a relational data storage area, to acquire the stored personality data structures and candidate attribute information from the relational data storage area, to input, to the generative AI model, prompt sentences that cause execution of similarity-based comparison between attribute information included in the personality data structures and attribute information of candidates and that cause determination, for each personality data structure, of a candidate to be supported, to aggregate, in the processor, support counts for each candidate based on simulation results, to perform statistical processing to identify a candidate with a high likelihood of winning, and to generate analysis result data including tabular data or graphic display data suitable for provision to an information distribution device. This enables technical improvement of computer-based prediction processing by unifying data generation, normalization, similarity-driven simulation, and result formatting through coordinated prompt-controlled interaction between the processor and the generative AI model, thereby increasing processing efficiency, scalability, and accuracy in large-scale election outcome prediction and related behavioral simulations.

The term “processor” refers to a hardware computation unit, or a combination of hardware computation units, that executes machine-readable instructions and controls operations of a system including data input, data processing, and data output.

The term “generative AI model” refers to an information processing model implemented in software and/or hardware that generates data, including text or structured data, in response to input prompt sentences, and that is trained using machine learning or deep learning techniques.

The term “prompt sentence” refers to a machine-interpretable instruction expressed in natural language or structured text that is provided to a generative AI model to cause the generative AI model to perform a specified processing operation or to generate specified output data.

The term “survey result information” refers to data representing responses collected from subjects in a survey, including but not limited to answers to questions regarding opinions, preferences, or behaviors, and optionally including metadata such as survey time, survey method, and region.

The term “demographic information” refers to data representing characteristics of a population or an individual, including at least one of age, gender, occupation, education level, residence, income level, or other population attributes.

The term “personality data structure” refers to a structured data representation of a virtual subject, including one or more fields that store attribute information associated with demographic information, preference information, and other characteristics of the virtual subject.

The term “virtual subject” refers to a hypothetical or simulated individual or entity that does not necessarily correspond to an actual person, and whose attributes and preferences are represented in a personality data structure.

The term “relational data storage area” refers to a logical region in an information storage device managed by a relational data management system and configured to store data in related tables in accordance with a relational schema.

The term “information storage device” refers to a hardware component or subsystem that non-transitorily stores data, such as a magnetic disk, optical disk, semiconductor memory, or a combination thereof.

The term “candidate object” refers to a data representation of a candidate or option in a selection process, including at least one of an identifier, profile information, and policy information.

The term “attribute information” refers to data representing properties, characteristics, or parameters associated with a subject, including demographic attributes, policy attributes, or preference attributes.

The term “preference behavior” refers to a behavior pattern indicating a selection or support decision made by a virtual subject among multiple candidate objects based on attributes and preferences of the virtual subject.

The term “simulation process” refers to a computational process executed by the processor and/or the generative AI model that models or imitates preference behavior of multiple virtual subjects under specified conditions.

The term “similarity calculation process” refers to a computation that quantifies a degree of similarity between two pieces of information, such as two text descriptions or two vector representations, using at least one similarity metric.

The term “vector representation” refers to a numerical representation of data, such as text or attributes, in a multi-dimensional space, which enables similarity calculation or other numerical operations.

The term “survey result preprocessing content” refers to a specification of operations applied to survey result information and demographic information before use in further processing, including at least one of summarization, normalization, filtering, or transformation of the data.

The term “aggregation result” refers to data representing a summarized outcome of processing over multiple records, including at least one of counts, totals, averages, distributions, or percentages.

The term “statistical processing” refers to a computational operation that applies one or more statistical methods, such as counting, averaging, variance calculation, regression, or probability estimation, to input data to derive analytical results.

The term “analysis result data” refers to data generated as a result of processing and analyzing simulation outputs, including at least one of aggregated values, prediction indices, and structured information suitable for visualization.

The term “tabular data” refers to data organized in rows and columns, for example in table form, such that each row represents a record and each column represents a field or attribute.

The term “graphic display data” refers to data formatted for visual representation, such as data for generating charts, graphs, or other visual elements on a display device.

The term “information distribution device” refers to an apparatus or system, such as a server device, a terminal device, or a broadcasting device, that distributes information, including analysis result data, to users or other systems via a communication network or other channels.

The server, the terminal, and the user cooperate to implement embodiments of the invention as described below. Each embodiment supports the claimed features and can be realized with conventional computer hardware combined with specific software components and data structures.

The server includes at least one processor, a main memory, a non-volatile storage device, and a network interface. The server uses a relational database management system such as a general-purpose relational database engine, an application framework such as a general-purpose web framework, and a generative AI model implemented as a large-scale neural network deployed on a remote or local computation platform. The terminal includes a display, an input interface, and a communication module, and may be implemented by a personal computer, a tablet device, or a smartphone. The user operates the terminal to supply information and to view analysis result data.

The server uses the generative AI model to generate, normalize, store, and simulate personality data structures. The generative AI model is implemented as a multi-layer neural network architecture, for example a transformer-based language model with multiple attention layers, feed-forward layers, and learned word and position embeddings. The generative AI model is trained in advance by supervised or self-supervised learning on a large corpus of text, using a loss function such as cross-entropy over token predictions. During training, an optimization algorithm such as stochastic gradient descent or a variant thereof updates model parameters, i.e., neural network weights, by backpropagation of errors computed by the loss function. The model learns internal vector representations that capture semantic relationships between words, phrases, and sentences, which the server exploits to perform similarity computations and structured data generation.

The server executes a program that causes the processor to communicate with the generative AI model by transmitting and receiving prompt sentences and model outputs. The server maintains a prompt-generation module, a normalization module, a similarity-computation module, and a result-aggregation module. Each module is implemented as a software component stored in the non-volatile storage device and loaded into main memory at runtime.

The server generates one or more prompt sentences for the generative AI model based on survey result information and demographic information. The server receives survey result information and demographic information from an external data source or from data files stored in the information storage device. The server represents this information in structured tables managed by the relational database engine. The server includes fields such as age range, gender distribution, occupation categories, education levels, and regional identifiers in a demographic table, and includes question identifiers, answer codes, and answer frequencies in a survey-result table.

The server converts these structured records into summarized textual descriptions and parameter lists. The server uses the prompt-generation module to construct prompt sentences that explicitly specify which attributes the generative AI model must use for generating personality data structures. For example, the server generates a prompt sentence such as:

“Generate 1,000 virtual voter profiles for a specific electoral district. Each profile should include age, gender, occupation, education level, and main policy preferences. The distribution of these attributes must match the following demographic summary: majority age between 30 and 50, balanced gender distribution, high proportion of office workers and service workers, and high school or university education.”

The server sends such prompt sentences to the generative AI model over a network using an application programming interface. The generative AI model processes the prompt sentence by tokenizing the text, embedding tokens into high-dimensional vectors, passing the vectors through multiple self-attention layers that compute context-dependent representations, and predicting output tokens that represent structured attribute values. The server receives the model output as structured text or as a semi-structured list of attribute-value pairs.

The server then applies the normalization module to transform the raw model outputs into a consistent personality data structure. The server maps free-text expressions such as “female” and “woman” to a canonical code representing gender, maps occupations to standard occupation codes, and maps policy preferences to controlled policy categories. The server verifies data types, for example ensuring that age values fall within plausible numeric ranges, and fills missing attributes with fallback values computed from demographic distributions. The server assigns unique identifiers to each personality data structure and stores the resulting records in relational tables using the relational database engine.

The server stores such personality data structures in a relational data storage area as multiple rows. Each row corresponds to one virtual subject and includes columns such as a personality identifier, age, gender code, occupation code, education code, region code, and a list of policy-preference codes. The server uses indices on frequently queried columns such as region code and policy-preference codes to accelerate retrieval. This specific data structure and indexing improve data management performance when millions of virtual subjects are generated.

The user operates the terminal to provide candidate information, including natural-language descriptions of candidate policies and profiles. The terminal transmits this candidate information to the server via a network connection. The server receives candidate names, brief biographies, and policy statements as raw text. The server stores candidate identifiers and basic profile attributes in relational tables, and stores each policy statement as a separate record linked to a candidate identifier.

The server then prepares the candidate policy information for similarity-based simulation. The server invokes the similarity-computation module, which uses a separate embedding model compatible with the generative AI model or integrated within the same model. The server converts each candidate policy description into a vector representation by sending a prompt sentence that instructs the generative AI model to output embedding values or normalized feature descriptors. Alternatively, the server applies a separate neural embedding model that shares vocabulary and architecture principles with the generative AI model. The server stores resulting vector representations in a dedicated table or in a vector index structure to facilitate fast similarity searches.

The server also converts preference information contained in the personality data structures into vector representations. The server constructs simple textual descriptions summarizing each personality's main policy preferences, such as “prefers education and childcare policies” or “strongly favors tax reduction and deregulation.” The server then calls the generative AI model or the embedding model with prompt sentences instructing the model to embed these preference sentences into numeric vectors. Because the generative AI model uses the same tokenization and embedding space for both candidate policies and personality preferences, the resulting vector representations are comparable in a shared semantic space.

The server executes similarity computations using an algorithm such as cosine similarity or dot product between vectors. The server uses linear algebra operations implemented by a numeric computation library. The server calculates a similarity score between each personality's preference vector and each candidate policy vector. The server then selects, for each personality, the candidate with the highest similarity score above a threshold as the supported candidate. The server records the identifier of the selected candidate as part of a simulation result record.

The server's use of shared embedding spaces and vector similarity computation constitutes a non-conventional technique compared to manually assigned preference weights. The server leverages high-dimensional representations learned by the generative AI model during training to detect subtle semantic relationships between natural-language descriptions and structured attributes. This improves the accuracy of preference simulation because the server can capture nuanced policy alignments that are not easily encoded by simple rule-based comparisons.

The server aggregates simulation results by counting, for each candidate, how many personality data structures support that candidate. The server executes aggregation queries against the relational database using group-by operations, and computes percentages and distributions. The server may perform additional statistical processing such as computing confidence intervals by running multiple simulation scenarios with varied prompts that adjust demographic distributions or preference weightings. The server then generates analysis result data comprising tabular configurations and graphical configuration templates suitable for rendering on various information distribution devices.

The server prepares analysis result data in formats that support multiple output devices without re-executing the underlying simulation or reformatting logic separately for each device. The server, for example, creates a device-independent data model containing candidate identifiers, counts, vote shares, and per-region breakdowns; and the server supplies this data to a rendering module that configures visualization for web browsers, display terminals, or broadcasting systems. By separating simulation logic and output rendering through a shared data model and by centralizing aggregation in the server, the system reduces duplicated formatting routines, lowers communication overhead, and decreases latency when delivering prediction updates.

The user may revise prompt sentences to test alternative electoral scenarios. For example, the user may input a prompt sentence such as:

“Generate 2,000 virtual voter profiles for young adults aged 20-29 in urban regions who have high interest in climate change and digital rights.” or

“Generate virtual voter profiles for older rural residents who prioritize agricultural subsidies and pension stability, keeping the total number of profiles at 1,500.”

The terminal sends these prompt sentences to the server, and the server adjusts generation parameters accordingly. The server instructs the generative AI model, by means of the new prompts, to generate personality data structures that reflect altered demographic and preference distributions. The server then repeats normalization, storage, embedding, similarity calculation, and aggregation on the updated population. This loop allows the server to efficiently explore multiple scenarios without rewriting simulation code; instead, the server modifies controlled parameters through prompt design, thereby improving flexibility and scalability of the overall computer system.

The server improves computer technology in several concrete ways. First, the server offloads complex feature construction and similarity computation to a generative AI model that is expressly controlled via structured prompt sentences. This reduces the need for hard-coded rule sets and manual feature engineering, which in turn reduces code complexity and improves maintainability. Second, the server uses a unified vector space for both voter preferences and candidate policies, enabling efficient similarity computations using vector operations that are highly optimized on modern processors and accelerators. This leads to improved processing speed when simulating large electorates comprising millions of personality data structures.

Third, the server uses relational indexing and normalized personality data structures to optimize database access patterns. By storing pre-computed personality vectors and candidate vectors, the server can avoid repeated embedding computation and can instead reuse pre-computed representations in subsequent simulation runs. This reduces computational load on the generative AI model and reduces network traffic between the server and the model, thereby lowering communication latency and enabling near-real-time updates of prediction results when candidate information or survey data change.

Fourth, the server integrates summarization and normalization of survey result information directly into prompt design. The server, rather than manually pre-processing raw data for each model call, generates prompt sentences that explicitly describe which attributes and value ranges the generative AI model should consider. This allows the model to internalize complex data distributions through its trained parameters and to synthesize personality data structures that more closely match target demographic profiles. This improves the fidelity of the simulation and reduces errors arising from misaligned population characteristics.

Fifth, the server controls the generative AI model to execute similarity calculations and embedding generation according to specific criteria. The server can, for example, specify in prompt sentences that policy descriptions be represented in a fixed number of dimensions or that certain semantic aspects such as economic policies or environmental policies receive higher emphasis. By encoding such weighting instructions in prompts and by leveraging the model's internal attention mechanisms, the server obtains vector representations that prioritize technically relevant features. This enables the server to perform more accurate and efficient preference matching than conventional systems that rely solely on keyword matching or manually crafted scoring rules.

The server can also implement alternative embodiments. In one embodiment, the server uses a locally deployed generative AI model executed on specialized hardware such as graphics processing units or tensor processing units. The server loads model parameters from local storage and executes forward passes of the neural network directly, without remote API calls. In another embodiment, the server uses a separate embedding model for similarity computation while still using the generative AI model for personality generation. In yet another embodiment, the server partitions the relational database by electoral district, and the server executes parallel simulation processes across multiple processing nodes to further accelerate large-scale analysis.

The terminal may also vary. In one embodiment, the terminal is a desktop computer running a browser-based user interface that communicates with the server via secure network protocols. In another embodiment, the terminal is a mobile device that uses an application to display interactive charts and allows the user to adjust parameters such as the number of virtual profiles, target demographics, and focus policies. The terminal can cache summary views and thereby reduce repeated data requests, which reduces communication load and improves responsiveness from the user's perspective.

The user can apply this system not only to election prediction but also to other large-scale preference simulations, such as forecasting adoption of public policies, products, or services. In these use cases, the user supplies different prompt sentences specifying other forms of preferences or decision criteria, and the server reuses the same underlying technical pipeline for generating personality data structures, computing similarities, and aggregating outcomes. The server's architecture remains oriented toward efficient data management and neural-model-based similarity, rather than being limited to a narrow business workflow.

Because the server structures processing around well-defined personality data structures, normalized candidate data, and vector-based similarity, the system is not a mere automation of human survey analysis. Instead, the system uses computational mechanisms that are not practically executable by human analysts, such as high-dimensional vector similarity across millions of synthetic profiles and candidate policies. The combinational use of generative AI models, relational databases, and optimized vector operations yields improvements in prediction accuracy, computational speed, and resource usage. These improvements arise from the specific configuration and interaction of hardware and software components described above, and they produce technical effects beyond merely organizing or displaying information.

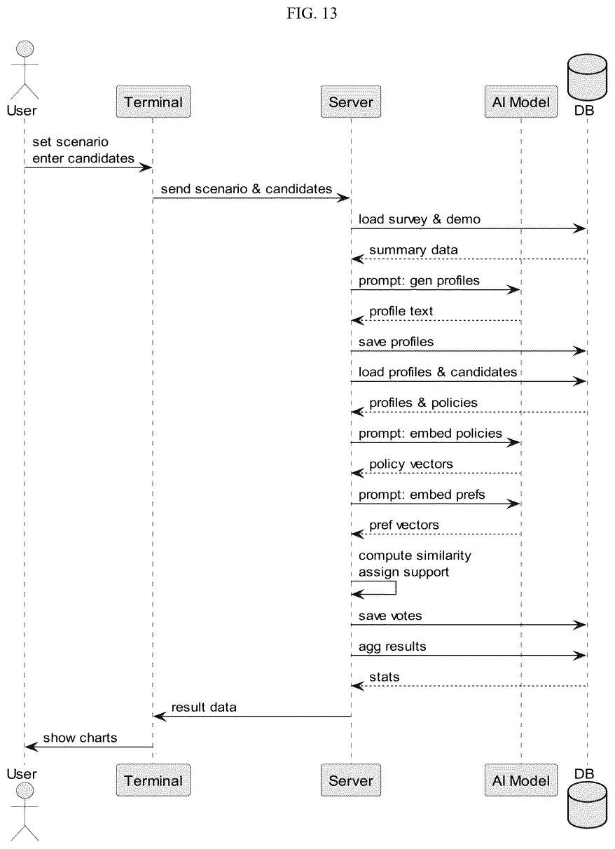

The following describes the processing flow using FIG. 13.

### Step 1

The user operates the terminal and initiates a scenario definition. The user inputs high-level conditions for an election simulation, such as target regions, target population segments, and the desired number of virtual subjects. The terminal receives this input as text and structured parameters and displays an interface for prompt design. The terminal sends the scenario definition to the server as request data. The input of this step is the user's scenario parameters, and the output is a structured scenario description transmitted from the terminal to the server.

### Step 2

The server receives the scenario description and acquires survey result information and demographic information corresponding to the specified regions from a relational database or external data source. The server reads records from survey tables and demographic tables using selection conditions derived from the scenario. The server aggregates raw values, such as counts and percentages, into summary statistics per age group, gender, occupation, and education level.

The input of this step is the scenario description and stored survey and demographic records, and the output is a summarized demographic and survey profile used for subsequent prompt generation.

### Step 3

The server generates a preprocessing prompt sentence for the generative AI model. The server converts the summarized demographic and survey profile into natural-language conditions and constraints. The server constructs a prompt sentence that explicitly specifies which attributes (for example, age, gender, occupation, education level, and policy preference categories) the generative AI model must use and what distributional properties must be satisfied. The server concatenates static template phrases and dynamically computed values to form a complete prompt sentence. The input of this step is the summarized demographic and survey profile, and the output is a preprocessing prompt sentence ready to be sent to the generative AI model.

### Step 4

The server sends the preprocessing prompt sentence to the generative AI model and receives a response indicating internal configuration or intermediate instructions if supported by the model.

The server may, for example, instruct the model to interpret specific attribute names or value ranges in a standardized way. The server uses this exchange to calibrate how the generative AI model will generate personality data structures in subsequent steps. The input of this step is the preprocessing prompt sentence, and the output is a model configuration acknowledgment or interpreted instruction set used internally by the server to refine later prompts.

### Step 5

The server generates a personality-generation prompt sentence for the generative AI model. The server takes the scenario parameters and the calibrated attribute definitions and formulates a detailed instruction such as: “Generate N virtual voter profiles with specified attributes and distributions.” The server includes numeric values, ranges, and categories derived from the demographic summary. The server structures the prompt so that each requested personality instance is described with fields like age, gender, occupation, education level, and policy preferences. The input of this step is the calibrated attribute definitions and scenario parameters, and the output is the personality-generation prompt sentence.

### Step 6

The server transmits the personality-generation prompt sentence to the generative AI model via a network interface. The server receives, as the model output, a textual or semi-structured description of multiple virtual subjects. The generative AI model internally tokenizes the prompt, processes tokens through its neural network layers, and outputs text tokens that represent attribute values. The server collects this output and parses it into candidate personality records.

The input of this step is the personality-generation prompt sentence, and the output is raw personality descriptions produced by the generative AI model.

### Step 7

The server normalizes the raw personality descriptions into personality data structures. The server parses each description line or block, extracts attribute-value pairs, and maps them onto canonical codes. The server converts text such as “male” or “man” into a standardized gender code, maps occupations to predefined occupation codes, and assigns numeric values to age fields. The server validates ranges, resolves ambiguities, and fills missing attributes with default or distribution-based values. The input of this step is the raw personality descriptions, and the output is a set of normalized personality data structures with consistent schema.

### Step 8

The server stores the normalized personality data structures in a relational data storage area. The server opens a connection to a relational database, constructs insertion statements or batch operations, and writes rows into a personality table that includes columns for identifier, age, gender code, occupation code, education code, region code, and policy preference codes. The server creates or updates indices on key columns to optimize retrieval. The input of this step is the normalized personality data structures, and the output is stored records in the relational database, each associated with a unique personality identifier.

### Step 9

The user operates the terminal and inputs candidate information and policy descriptions. The user enters candidate names, affiliations, and natural-language descriptions of policy positions, for example, “promote education reform and expand childcare support.” The terminal validates input formats and sends the candidate data to the server in a structured request. The input of this step is the user-entered candidate and policy text, and the output is a candidate registration request transferred from the terminal to the server.

### Step 10

The server receives the candidate registration request and stores candidate attribute information in the relational database. The server inserts candidate identifiers and profile fields into a candidate table and stores each policy description in an associated policy table linked via foreign keys. The server performs basic text cleaning, such as trimming whitespace and normalizing character encoding. The input of this step is the candidate registration request, and the output is a set of candidate and policy records stored and indexed for later retrieval and processing.

### Step 11

The server prepares candidate policy text for embedding. The server retrieves stored policy descriptions from the policy table and groups them by candidate identifier. The server may concatenate multiple policy statements for a candidate into a single coherent text segment or maintain them as separate segments. The server creates a list of policy texts to be converted into vector representations. The input of this step is candidate and policy records from the database, and the output is a structured list of policy texts keyed by candidate identifiers.

### Step 12

The server generates embedding request prompt sentences or formatted inputs for the generative AI model (or a companion embedding model). The server specifies, for each policy text, that the model should output a numerical representation capturing semantic content. The server may embed this instruction in a prompt sentence such as: “Produce a numeric feature vector representation of the following policy statement, preserving distinctions between economic, social, and environmental policies.” The input of this step is the list of policy texts, and the output is a collection of embedding request prompts or formatted embedding inputs.

### Step 13

The server sends the embedding requests to the generative AI model or a separate embedding model and receives vector representations. The server processes each policy text, waits for a response containing numeric values, and stores the resulting vectors in memory. The server may normalize vectors to unit length for cosine similarity computations. The input of this step is the embedding request prompts and policy texts, and the output is a set of policy vectors associated with candidate identifiers.

### Step 14

The server converts preference information in the personality data structures into textual summaries for embedding. The server formulates a short sentence for each personality, such as “prefers education and childcare policies” or “strongly favors tax reduction and deregulation.”

The server uses the policy preference codes stored in the personality records to generate these sentences programmatically. The input of this step is the personality data structures with preference codes, and the output is a list of preference summary texts associated with personality identifiers.

### Step 15

The server generates embedding requests for the preference summary texts and sends them to the generative AI model or embedding model. The server instructs the model, via prompt sentences, to produce vectors that represent the preference content in the same vector space as the policy vectors. The server receives the vectors and may perform normalization. The input of this step is the preference summary texts, and the output is a set of preference vectors associated with personality identifiers.

### Step 16

The server performs similarity computations between preference vectors and policy vectors. The server, for each personality vector, calculates similarity scores with all candidate policy vectors using a similarity metric such as cosine similarity. The server uses linear algebra operations implemented in a numeric library to compute dot products and norms. The server generates a similarity matrix where rows represent personalities and columns represent candidates. The input of this step is the preference vectors and policy vectors, and the output is similarity scores that quantify alignment between each personality and each candidate.

### Step 17

The server determines supported candidates for each personality based on the similarity scores. The server selects, for each personality, the candidate with the highest similarity value above a predetermined threshold. The server applies tie-breaking rules if multiple candidates share similar scores. The server creates a simulated vote record that links each personality identifier to the selected candidate identifier. The input of this step is the similarity scores, and the output is a set of simulated support assignments for each personality.

### Step 18

The server stores simulated vote records in the relational database. The server inserts rows into a simulation result table that includes fields such as simulation run identifier, personality identifier, candidate identifier, and timestamp. The server may batch these insertions to reduce database overhead and maintain transaction integrity. The input of this step is the simulated support assignments, and the output is persistent simulation result records that can be queried for aggregation and analysis.

### Step 19

The server aggregates simulation results to compute support counts and vote shares per candidate. The server executes group-by and count operations on the simulation result table, optionally joined with personality tables to segment by region or demographic attributes. The server calculates total votes for each candidate and derives percentages relative to the total number of simulated votes. The input of this step is the simulation result records, and the output is aggregated support statistics for each candidate and each defined segment.

### Step 20

The server generates analysis result data in a format suitable for multiple information distribution devices. The server converts aggregated statistics into tabular data structures and graphic configuration data such as series labels, values, and axis definitions. The server may produce generic JSON-like representations that can be rendered into bar charts, pie charts, or line graphs by downstream visualization components. The input of this step is the aggregated support statistics, and the output is analysis result data that contains prediction information and is ready for distribution.

### Step 21

The terminal requests analysis result data from the server and renders it for the user. The terminal sends a query specifying the simulation run or region of interest. The server responds with the previously prepared analysis result data. The terminal interprets this data and draws visual elements, such as charts and tables, on the display. The input of this step is the user's request for results and the analysis result data returned by the server, and the output is a visual presentation that shows predicted winners, vote distributions, and demographic breakdowns on the terminal screen.

### Step 22

The user reviews the displayed results and optionally refines the scenario. The user may decide to change demographic assumptions, adjust the focus of policy categories, or vary the number of virtual subjects. The user modifies these parameters on the terminal and enters updated prompt sentences, such as “Generate 3,000 additional virtual profiles with higher interest in environmental policies.” The terminal sends the updated scenario and prompts to the server. The input of this step is the user's revised parameters and prompt sentences, and the output is a new or updated scenario definition that triggers another iteration of the described processing flow.

### Application Example 2

Description follows regarding a flow of the specific processing in an Application Example 2.

The units of the system described below are implemented by the data processing device 12 and the smart device 14. The data processing device 12 is called a “server” and the smart device 14 is called a “terminal”.

Conventional computer-implemented election prediction and advertising systems suffer from several technical limitations in how information is represented, processed, and delivered in real time.

First, existing systems typically operate on coarse, aggregate statistical data and apply static statistical models. Such systems are not architected to internally represent a population as a large number of structured, machine-readable virtual individual objects that reflect both demographic attributes and dynamically changing emotional states. As a result, the internal data structures and processing pipelines cannot flexibly simulate complex, large-scale preference behavior, and the systems struggle to update predictions accurately when new emotion-related information, such as social media sentiment, becomes available.

Second, many systems separate election prediction processing from advertising optimization processing. The technical workflows, data schemas, and computation paths for prediction and advertising are often implemented as independent subsystems. This separation leads to duplicated data transformations, redundant calls to external analysis modules, and inconsistent use of prediction outputs for downstream tasks such as advertisement selection. Consequently, system latency increases, resource utilization is inefficient, and it becomes difficult to ensure consistency between predicted election outcomes and generated advertising strategies.

Third, conventional systems do not use a generative AI model in a structured, machine-orchestrated manner via prompt sentences to control multiple stages of processing, including virtual individual generation, large-scale simulation control, prediction result formatting, and advertising optimization. Instead, generative models, if used at all, are often invoked in ad hoc fashion and not integrated into a deterministic control layer. Without an architecture that programmatically generates standardized prompt sentences and uses them as control signals for the generative AI model, the system cannot reliably coordinate complex multi-stage workflows, cannot easily adapt the level of detail and format of prediction outputs for different information distribution targets, and cannot efficiently reuse the same underlying persona and simulation data for both prediction and real-time personalization.

Fourth, conventional systems are technically limited in how they incorporate real-time emotion analysis into both election simulation and advertisement delivery at scale. Emotion analysis is often performed as a separate analytic function, and its outputs are not tightly integrated into the core internal representations (such as persona objects) or into the control logic for simulation models and ad selection. As a result, updates to user emotional state or group emotional state cannot be propagated efficiently through the prediction and ad optimization pipeline, leading to stale or misaligned results and increasing the computational cost of resimulation.

Therefore, there is a need for a computer-implemented system that improves the way processors preprocess heterogeneous election-related and emotion-related data, generate and manage large sets of structured virtual individual objects, orchestrate simulations and data formatting through prompt sentences to a generative AI model, and jointly utilize election prediction results and emotion-aware advertising optimization in a unified pipeline. Such a system should improve the internal data structures and computational flow so as to reduce redundant processing, enable dynamic, emotion-aware simulations, and provide low-latency, consistent outputs suitable both for information distribution apparatuses and for real-time personalized advertisement delivery to terminal devices.

The specific processing by the specific processing unit 290 of the data processing device 12 in Application Example 2 is realized by the following means.

The present invention provides a server comprising a processor configured to preprocess input information acquired from information sources including small-scale preliminary survey results for each electoral district, population attribute information, and emotion-related information, and to generate integrated feature data for each electoral district; to generate a prompt sentence that instructs a generative AI model to generate, based on the integrated feature data, a plurality of virtual individual objects having structured attributes including age, gender, occupation, education level, and emotional state for each electoral district, and to input the prompt sentence into the generative AI model so as to obtain person objects or virtual individual objects; to generate a prompt sentence that instructs the generative AI model to perform a preference behavior simulation that mimics a large-scale survey by associating the person objects or virtual individual objects with policy information or attribute information of candidate entities and calculating, for each candidate entity, a vote probability or winning probability, and to input the prompt sentence into the generative AI model; to aggregate results of the preference behavior simulation to generate election result prediction data including statistical indices and confidence intervals; to generate a prompt sentence that instructs the generative AI model to generate, based on the election result prediction data, media provision prediction result data including tabular data, visualization data, and descriptive text data in output formats corresponding to different information distribution apparatuses, and to input the prompt sentence into the generative AI model; to output the media provision prediction result data to an information distribution apparatus via a communication path so that the media provision prediction result data is used for reporting or distribution by the information distribution apparatus; to generate a prompt sentence that instructs the generative AI model to perform a simulation for estimating a response degree to advertisement information based on combinations of the person objects or virtual individual objects and the advertisement information and for optimizing an advertisement placement plan or advertisement content, and to input the prompt sentence into the generative AI model; to select advertisement information to be presented to a user from among the advertisement placement plan or the advertisement content based on user attribute information and user emotional state information acquired from a terminal device; and to transmit the selected advertisement information to the terminal device so that the advertisement information is displayed or reproduced on the terminal device. This enables an integrated, computer-implemented workflow in which election-related and emotion-related data are transformed into unified feature representations, used to generate detailed virtual individual objects, and processed through coordinated simulations and formatting steps under programmatically generated prompt sentences to the generative AI model, thereby improving internal data structures, reducing redundant computations, enabling dynamic emotion-aware election prediction, and facilitating low-latency, consistent delivery of both prediction information to information distribution apparatuses and personalized advertisement content to terminal devices.

The term “processor” refers to a hardware computing element or a set of hardware computing elements, including a central processing unit or other arithmetic logic circuitry, that executes machine-readable instructions to perform data processing operations.

The term “information source” refers to a logical or physical origin of data, including databases, network services, application programming interfaces, and storage devices, from which election-related, demographic, or emotion-related information is obtained.

The term “small-scale preliminary survey result” refers to data representing responses collected from a relatively limited number of subjects in advance of an election or other event, the data including at least respondent opinions or intentions associated with an electoral district.

The term “population attribute information” refers to demographic or socio-economic data representing characteristics of a group of individuals in a region, including at least age distribution, gender distribution, occupation distribution, and education level distribution.

The term “emotion-related information” refers to data indicative of an emotional state or sentiment of individuals or groups, derived from text, audio, or other content, and including at least numerical scores or categorical labels such as anxiety, stress, hope, or anger.

The term “integrated feature data” refers to structured data generated by combining and preprocessing multiple kinds of input information, including survey results, population attribute information, and emotion-related information, into a unified representation suitable for machine learning or simulation.

The term “generative AI model” refers to a machine-learned model, such as a neural network, configured to generate structured or unstructured output data from input data or from a prompt sentence, the output including at least virtual individual objects, simulation results, or narrative text.

The term “prompt sentence” refers to a machine-readable instruction string, including natural language or structured commands, provided to a generative AI model to specify a processing task or an output format to be performed or generated by the model.

The term “virtual individual object” refers to structured data representing a hypothetical individual, the data including at least demographic attributes, behavioral attributes, and optionally an emotional state, and being generated using the generative AI model based on integrated feature data.

The term “person object” refers to a virtual individual object that represents a simulated person associated with an electoral district and having attributes including age, gender, occupation, education level, and emotional state.

The term “attribute” refers to a data field or feature associated with an object, including at least age, gender, occupation, education level, emotional state, policy preference, or any other characteristic used in simulation or prediction.

The term “electoral district” refers to a geographic or administrative unit in which an election is conducted and for which election predictions or simulations are performed.

The term “candidate entity” refers to a logical representation of a person or organization that is a potential selection target in an election or decision process, and is associated with policy information or attribute information.

The term “policy information” refers to structured or semi-structured data describing positions, proposals, or stances of a candidate entity with respect to one or more issues, such as economy, environment, healthcare, or security.

The term “preference behavior simulation” refers to computational processing that, using person objects or virtual individual objects and candidate entity information, estimates or simulates selection behavior such as voting, thereby generating vote probabilities or winning probabilities for candidates.

The term “large-scale survey” refers to a conceptual or actual data collection activity targeting a large number of individuals, and, in the context of the invention, includes virtual surveys simulated using virtual individual objects.

The term “vote probability” refers to a numerical value representing a likelihood that a person object or virtual individual object will select a particular candidate entity in a simulated election.

The term “winning probability” refers to a numerical value representing a likelihood that a candidate entity will win an election in an electoral district, based on aggregated simulated voting behavior.

The term “election result prediction data” refers to structured data derived from aggregation of preference behavior simulation results, including at least predicted vote shares, winning probabilities, statistical indices, and confidence intervals for candidate entities.

The term “statistical index” refers to a numerical descriptor computed from simulation or prediction results, including at least mean, variance, percentage, or other summary values that characterize election outcomes.

The term “confidence interval” refers to an interval estimate associated with a statistic, indicating a range within which a true value of a prediction metric, such as vote share or winning probability, is expected to fall with a prescribed confidence level.

The term “media provision prediction result data” refers to election result prediction data that has been converted or augmented into a format suitable for consumption by an information distribution apparatus, and that includes at least tabular data, visualization data, or descriptive text data.

The term “tabular data” refers to data arranged in rows and columns, such as a table or spreadsheet, expressing relationships between variables including electoral districts, candidate entities, and prediction values.

The term “visualization data” refers to data representing graphical elements, such as charts, graphs, or maps, that are generated from prediction results and suitable for visual display on a screen or in a printed medium.

The term “descriptive text data” refers to narrative or explanatory text generated to describe or interpret prediction results, including summaries, highlights, and explanations of factors influencing outcomes.

The term “information distribution apparatus” refers to a computing system or device operated by a media entity or other information provider, configured to receive, store, and distribute or broadcast content, including prediction results, to end users.

The term “communication path” refers to a logical or physical communication channel, including wired or wireless networks, through which data is transmitted between the server, terminal devices, and information distribution apparatuses.

The term “advertisement information” refers to data representing a promotional message or content, including text, image, audio, or video elements, intended to influence user behavior with respect to goods, services, or ideas.

The term “response degree to advertisement information” refers to a predicted or measured indicator, such as probability of click, conversion, engagement, or attitude change, representing how a person object, virtual individual object, or user is expected to react to advertisement information.

The term “advertisement placement plan” refers to structured data specifying a schedule, targeting criteria, channel selection, and allocation of advertisement information to audience segments or media slots.

The term “advertisement content” refers to the substantive portion of advertisement information, including the creative message, visual design, audio material, and other presentation elements.

The term “user attribute information” refers to data describing characteristics of a specific end user, including at least age, gender, location, device type, interests, and historical interaction behaviors.

The term “user emotional state information” refers to data representing an inferred or measured emotional condition of a user at a given time, expressed as one or more categorical labels or numerical scores obtained through emotion analysis.

The term “terminal device” refers to an end-user computing device, such as a smartphone, tablet, personal computer, or other client device, capable of communicating with the server and presenting information or advertisements to a user.

The term “emotion analysis function” refers to software or a combination of software and hardware configured to receive input content such as text, audio, or video, and to output emotion-related information including emotion labels or scores.

The term “group emotion information” refers to aggregated emotion-related information computed from emotion analysis of content associated with multiple individuals, and representing emotional tendencies of a group within an electoral district or user segment.

In one embodiment, a server, one or more terminal devices, and one or more information distribution apparatuses are interconnected via a communication network. The server comprises at least one processor, a main memory, a nonvolatile storage device, and a network interface.

The processor is, for example, a multi-core general-purpose processor. In some embodiments, the server further comprises one or more graphics processing units used for neural network training and inference acceleration. The terminal is, for example, a smartphone, a tablet computer, or a personal computer including a local processor, a display unit, a user input unit, and a network interface. The information distribution apparatus is, for example, a computing system operated by a media provider and configured to receive, store, and distribute content.

The server stores in the storage device a set of software modules, including an operating system, a database management system such as a relational database engine, and application modules implemented, for example, in a high-level programming language. The application modules include at least: a data acquisition module, a preprocessing module, a feature construction module, a neural network training module, a generative AI interface module for handling interactions with a generative AI model, a simulation module, a reporting module, and an advertisement optimization module.

The server acquires input data from multiple information sources. The server accesses survey data sources to obtain small-scale preliminary survey results for each electoral district. The server accesses demographic data sources to obtain population attribute information including age distribution, gender distribution, occupation distribution, and education level distribution.

The server accesses content or log data sources to obtain emotion-related information. The emotion-related information includes, as one example, text content such as social media posts associated with users in each electoral district.

The server uses the preprocessing module to clean, normalize, and encode the acquired data. The server converts raw survey records into a fixed-length feature representation per respondent, for example by mapping categorical values to index values, normalizing numerical values, and removing impossible or inconsistent values. The server converts demographic data into structured distributions, for example by computing histograms over age ranges, gender, and occupational categories for each electoral district. The server converts emotion-related information into numerical emotion vectors by invoking an emotion analysis function. In one embodiment, the server sends text strings to an external emotion analysis application and receives, for each text, a vector of real numbers indicating intensities of multiple emotion dimensions such as joy, anger, fear, and sadness. The server aggregates these vectors by electoral district and, optionally, by age group, so that each electoral district is associated with group emotion information.

The server uses the feature construction module to combine the processed survey results, the population attribute information, and the group emotion information into integrated feature data.

The integrated feature data has a predetermined structure, for example a vector or tensor containing: survey-derived preference statistics, demographic distributions, and aggregated emotion scores. The server stores the integrated feature data in the database in association with identifiers of electoral districts.

The server uses the neural network training module to train an internal generative model for virtual individual objects. In one embodiment, the server constructs a variational autoencoder.

The encoder portion of the variational autoencoder receives, as input, feature vectors representing real respondents or aggregate district-level vectors. The encoder outputs latent variables characterized by mean and variance parameters. The decoder portion receives latent variables and reconstructs individual-level attribute vectors including age, gender, occupation, education level, and base preference values. During training, the server repeatedly computes a reconstruction loss between the decoder output and target attribute vectors, as well as a regularization term such as a Kullback-Leibler divergence between the latent distribution and a standard normal distribution. The server uses an optimization algorithm to update weight parameters of the encoder and decoder networks. The processor executes linear algebra operations, including matrix multiplication and non-linear activation functions, to minimize the loss function. By training in this manner, the variational autoencoder learns a latent space from which new virtual individual objects consistent with observed data can be sampled.

Alternatively, the server uses a generative adversarial network, in which a generator network maps random noise vectors and district-level conditioning vectors into virtual individual attribute vectors, while a discriminator network receives a mix of real and generated attribute vectors and outputs a probability indicating whether a given vector is real or generated. The server updates generator and discriminator weights alternately based on adversarial loss functions. The structure of these neural networks, including numbers of layers, numbers of units, non-linear activation types, and regularization parameters, is stored as part of the system configuration and can be selected depending on hardware capability and data volume.

The server further trains a prediction model for preference behavior simulation. In one embodiment, the server constructs a neural network that takes as input a combined feature vector including at least: encoded attributes of a person object or virtual individual object, encoded features of a candidate entity, and emotion features associated with the person object. The neural network outputs, for each candidate entity, a probability value indicating a likelihood that the given individual will select the candidate in an election. The server defines a loss function, for example cross-entropy between predicted probabilities and observed choices for training samples where actual votes or survey responses are known. The server performs supervised learning by repeatedly computing the gradient of the loss function with respect to network weights and updating the weights using an optimization algorithm. Through this training, the network becomes capable of mapping high-dimensional individual and candidate features to accurate vote probability predictions, which cannot be reasonably achieved by simple linear models or manual rules.

In addition to the internal models, the server uses the generative AI interface module to interact with at least one external generative AI model that processes prompt sentences. The external generative AI model is, for example, a large-scale transformer-based neural network trained on natural language. The server stores, in the storage device, templates and rules for constructing prompt sentences. The server generates prompt sentences in a deterministic, rule-based manner, by filling parameterized text templates with dynamically derived values such as district identifiers, target numbers of virtual individuals, and fields to be included in outputs. By centrally managing prompt creation in this way, the server ensures that the generative AI model receives consistent and machine-interpretable instructions, reducing failures and ambiguous responses.

For example, when generating virtual individual objects, the server constructs a prompt sentence of the following form:

“Based on the following integrated feature data for Electoral District A, including demographic distributions, preliminary survey statistics, and group emotion scores, generate 500,000 persona objects. Each persona object shall include fields: id, age, gender, occupation, education level, baseline political preference, and emotional_state. Output the persona objects as a machine-readable list.”

The server appends a textual description of the integrated feature data to the prompt sentence and sends the prompt sentence to the generative AI model. The server then receives output text, parses it according to expected markers or separators, and extracts virtual individual objects.

Because the server has pre-defined both structure and field names, automatic parsing is possible, and inconsistencies can be detected.

As another example, when controlling a preference behavior simulation via the generative AI model, the server constructs a prompt sentence such as:

“Using the attached persona objects and candidate policy profiles for Electoral District A, simulate a large-scale election survey and estimate, for each candidate, the predicted vote share and winning probability. Consider the emotional_state field of each persona when determining sensitivity to economic and social policies. Return a summary table of predicted vote shares and winning probabilities, and provide a short textual explanation of key factors.”

The server again transmits this prompt sentence together with structured data and interprets the response from the generative AI model. The server may use both the external generative AI model and the internal simulation model in a complementary manner: for example, the server uses the internal prediction model for numerical computations and uses the generative AI model primarily for orchestration instructions and narrative explanations.

The server uses the simulation module to run preference behavior simulations at scale using the trained prediction model. The server loads a set of virtual individual objects for a given electoral district, loads candidate policy information, and constructs a data structure in which each record contains features describing a virtual individual and features describing a candidate. The server processes batches of such records through the prediction model to obtain vote probabilities. The server then stores, for each virtual individual, the candidate identifier associated with the highest probability. Because the prediction model is implemented as a multi-layer neural network and executed on optimized hardware, the server can compute vote probabilities for millions of virtual individuals and dozens of candidates with significantly reduced latency compared with interpreters of handcrafted rules.

The server uses the reporting module to aggregate results of simulations for each electoral district. The server counts, for each candidate, how many virtual individuals select the candidate.

The server derives predicted vote shares and winning probabilities from these counts, optionally applying statistical re-weighting to emulate turnout variations or sampling bias corrections. The server computes statistical indices, such as mean vote share and standard deviation across repeated simulations, and computes confidence intervals using, for example, bootstrap resampling methods. The server generates election result prediction data structures that encode these values.

The server then uses the generative AI interface module to format prediction results for different information distribution apparatuses. In one case, the server constructs a prompt sentence such as:

“Format the following election prediction data for publication by a national news outlet.

Generate: (1) a tabular layout listing, for each electoral district, each candidate and predicted vote share; (2) a description of three main trends; and (3) a short explanation in plain language of how voter emotions affected the predictions.”

The server attaches the raw numeric prediction data and transmits the prompt sentence to the generative AI model. The server receives as output formatted tabular data in text form and descriptive paragraphs. The server merges the tabular and narrative content into one or more documents and transmits them to an information distribution apparatus over the communication path, for example as files or API responses. In another case, the server directly produces charts and graphs using a visualization library running on the processor; the server may ask the generative AI model only to create captions or summaries accompanying the charts.

The server also coordinates advertisement-related processing using the same underlying virtual individual objects and prediction framework. The server stores an advertisement catalog containing advertisement information, including topic, tone, medium, and cost parameters. The server trains an advertisement response model using historical log data. In one embodiment, the advertisement response model is a neural network that takes as input: features extracted from a virtual individual object or user profile, emotion features, and encoded features describing an advertisement. The network outputs, for example, a probability of click or conversion. The server trains this model using a supervised learning method with cross-entropy loss between predicted probabilities and observed click labels. During training, the server applies data augmentation techniques, such as random perturbations of non-critical features, to improve generalization and reduce overfitting.

For offline simulation, the server combines each virtual individual object with multiple candidate advertisements and invokes the advertisement response model to estimate response degrees, such as predicted click-through rate or persuasion probability. The server aggregates the responses over a target segment, such as “20-year-old university students,” and determines which advertisement content and channel combination results in the highest expected response given a budget constraint. The server constructs an advertisement placement plan specifying, for example, which advertisement content to deliver to which demographic and emotional segments, and through which channel and time window.

To further refine the advertisement placement plan, the server sends a prompt sentence to the generative AI model, such as:

“Using the simulated response data for 20-year-old university students, propose an advertising strategy that maximizes engagement. Specify recommended advertisement messages, media channels, and time slots.”

The server receives a proposed plan in natural language and maps the described elements onto concrete entities in the advertisement catalog and targeting options in advertising platforms.

For real-time personalization, the terminal gathers user attribute information and user emotional state information. The terminal obtains user attribute information from local storage, initial registration data, or operating system interfaces. The terminal obtains user emotional state information by monitoring content entered by the user, such as text typed in search boxes, comments, or messages, and transmitting the text to the server for emotion analysis. The terminal packages these data items and transmits them via the communication network to the server.

The server updates a user profile record stored in the database with the received user attribute information and emotion state. The server then uses an advertisement selection algorithm that combines rule-based filtering and neural network-based scoring. First, the server filters out advertisements that do not match basic constraints such as age range or regional availability.

Then, for each remaining advertisement, the server constructs a feature vector from the user profile and advertisement attributes and computes a predicted response degree using the advertisement response model. The server selects the advertisement associated with the highest predicted response degree that also satisfies business or regulatory constraints.

In some embodiments, the server further uses the generative AI model to generate or explain selection decisions. For example, the server constructs a prompt sentence such as:

“User profile: 35-year-old female, office worker, lives in a big city, emotional_state=‘stressed about politics’. Available advertisements: A, B, C (with summaries). Select the most suitable advertisement to reduce stress and increase trust, and describe the reasoning in two sentences.”

The server sends the prompt sentence and advertisement summaries to the generative AI model and receives a recommended advertisement and explanation. The server may use this recommendation directly or reconcile it with the neural network-based scoring to achieve both quantitative optimization and qualitative consistency.

The server transmits the selected advertisement information to the terminal. The terminal receives identifiers of the advertisement content, display parameters, and possibly narrative text, and renders the advertisement on the display. The terminal may play audio or video material, and may track interaction events such as impressions and clicks. The terminal transmits these interaction logs back to the server, closing the feedback loop for continued training and refinement of the advertisement response model.

The described architecture yields several technical effects beyond a mere automation of human analysis. Because the server represents a population as large sets of virtual individual objects with structured attributes and emotions, the server can reuse these objects across multiple simulations and use cases. This reuse reduces the need to repeatedly fetch and process raw survey and demographic data. The integrated feature data and persona data structures enable dense vectorized computations, which are highly suitable for execution on modern processors and specialized accelerators, thereby improving throughput and reducing latency. The server's use of trained neural networks for vote probability and advertisement response estimation allows nonlinear, high-dimensional relationships among variables to be captured in a compact set of weight parameters, while still being computed efficiently via matrix operations.

By orchestrating multi-stage workflows through programmatically generated prompt sentences, the server uses the generative AI model as a controlled computation module that can adapt formatting, explanation, and scenario configuration without modifying the underlying core code.

This reduces code complexity and allows the system to flexibly change output styles and scenario parameters while preserving a consistent internal representation. The prompt sentence templates and their automatic generation constitute a set of deterministic rules that are not natural extensions of typical manual or ad hoc uses of generative models; instead, they define a machine-level protocol between the server and the generative AI model. This controlled use of the generative AI model contributes to reduced parsing errors, robust handling of large-scale outputs, and improved data management within the server.

Incorporating emotion-related features into both the persona generation and the prediction models improves the predictive accuracy of election outcomes and advertisement responses. The server's emotion-aware architecture allows group emotion information and user emotional state information to be fused into integrated feature data in a structured way. This design improves the signal-to-noise ratio of inputs to the neural networks and reduces the need for repeated ad hoc analysis of raw text content, thereby reducing computational cost. Further, by storing emotion-aware persona objects and using them in both election simulation and advertisement optimization, the system avoids duplicating state in separate subsystems and reduces memory overhead.

The server implements specific data flows and module interactions rather than a generic “data collection, analysis, display” pattern. For example, the generation of integrated feature data, the training of a persona generator conditioned on that data, the use of a dedicated prediction network for vote probability, and the subsequent formatting of prediction data through targeted prompt sentences collectively define a specific technical pipeline. This pipeline is tailored to run efficiently on the server hardware and to produce machine-consumable outputs suitable for immediate use by information distribution apparatuses and terminal devices. The structure of the data, including strongly typed fields in persona objects and prediction records, enables indexing, caching, and incremental updates, contributing to improved data management and reduced communication load.

Alternative embodiments can vary specific implementation details while maintaining the technical concept. In one embodiment, the server replaces the variational autoencoder with another generative model, such as an autoregressive model for persona attributes. In another embodiment, the prediction model is implemented as a gradient boosted decision tree ensemble rather than a neural network, while still receiving integrated feature data and producing vote probabilities. In still another embodiment, the emotion analysis function is implemented directly on the server using a convolutional or transformer-based text classifier rather than an external service, and emotion features are derived from internal model outputs.

In all these embodiments, the server, the terminal, and the information distribution apparatus cooperate to realize a system that uses integrated feature data, virtual individual objects, neural network-based estimators, and structured prompt sentences to a generative AI model to improve the technical efficiency, scalability, and accuracy of election prediction and advertisement optimization processing, thereby providing an improved computer-implemented technology rather than a mere automation of human mental analysis.

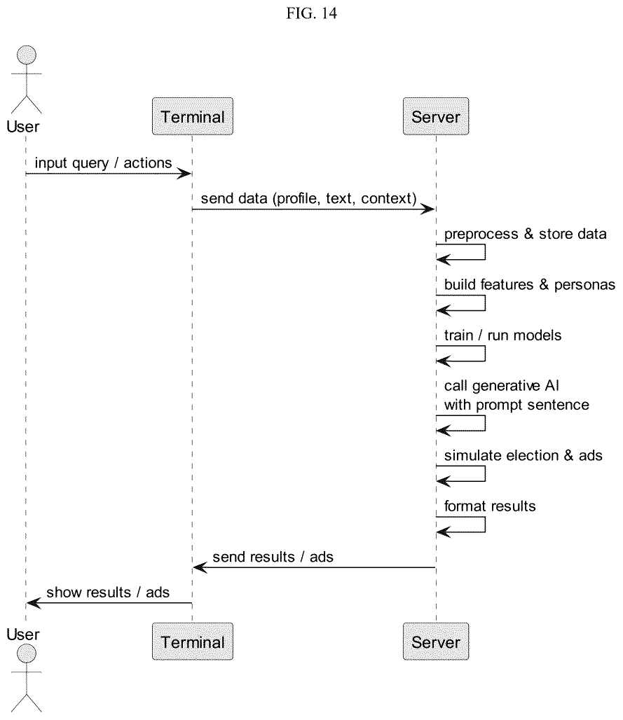

The following describes the processing flow using FIG. 14.

### Step 1

The server acquires raw input data from multiple information sources.

The server receives as input: (i) small-scale preliminary survey results per electoral district, (ii) population attribute information such as demographic statistics, and (iii) emotion-related information such as text posts or logs.

The server sends network requests to external data services and database queries to internal storage, and writes the retrieved raw records into staging tables in a database. The server outputs stored raw data tables partitioned by electoral district and data type.

### Step 2

The server preprocesses and normalizes the raw tabular data.

The server receives as input the raw survey tables and population attribute tables for each electoral district.

The server removes duplicate and inconsistent records, fills missing values using statistical methods, and converts categorical fields such as gender and occupation into numerical encodings. The server outputs cleaned and encoded tabular datasets representing survey responses and demographic distributions in a machine-learning-ready format.

### Step 3

The server derives emotion-related feature data.

The server receives as input text content and metadata included in the emotion-related information, such as social posts associated with electoral districts or user segments.

The server calls an emotion analysis function for each text entry, receives numerical scores or labels for multiple emotion categories, and aggregates these scores per electoral district and optionally per age group. The server outputs group emotion feature tables that attach average emotion scores to each electoral district.

### Step 4

The server constructs integrated feature data for each electoral district.

The server receives as input the normalized survey data, the population attribute data, and the group emotion feature tables.

The server joins these datasets on electoral district identifiers and constructs fixed-length feature vectors or tensors that include survey-derived statistics, demographic distributions, and emotion scores. The server outputs integrated feature data records keyed by electoral district.

### Step 5

The server trains an internal generative model for virtual individuals.

The server receives as input example attribute vectors derived from real respondents and the integrated feature data.

The server initializes parameters of a neural network model, computes reconstruction or adversarial losses on training examples, and repeatedly updates model weights using an optimization algorithm until convergence criteria are met. The server outputs a trained generative model capable of sampling attribute vectors that resemble realistic individuals conditioned on district-level features.

### Step 6

The server trains a prediction model for individual preference behavior.

The server receives as input labeled training data that pairs individual attribute vectors, candidate feature vectors, and observed choices from historical elections or surveys.

The server constructs combined feature inputs for each individual-candidate pair, computes predicted probabilities, and minimizes a loss function such as cross-entropy by adjusting network weights. The server outputs a trained prediction model that maps persona and candidate features to vote probabilities.

### Step 7

The server generates persona or virtual individual objects for each electoral district.

The server receives as input the trained generative model and the integrated feature data for each electoral district.

The server feeds district-level feature vectors into the generative model, samples latent variables, and decodes them into individual-level attribute vectors. The server wraps each attribute vector into a structured persona object containing fields such as age, gender, occupation, education level, baseline preference, and emotional_state. The server outputs large collections of persona objects grouped by electoral district.

### Step 8

The server refines persona objects with the assistance of a generative AI model using prompt sentences.

The server receives as input initial persona templates and the integrated feature data.

The server constructs a prompt sentence instructing the generative AI model to generate or augment persona objects, attaches textual descriptions of the integrated feature data, and sends this prompt sentence to the generative AI model. The server parses the generated text response, validates object fields, and updates or enriches persona objects with additional attributes or explanations. The server outputs refined persona object collections with consistent structures.

### Step 9

The server prepares candidate entity feature data.

The server receives as input raw policy descriptions and profile information for candidate entities.

The server tokenizes and encodes policy texts, maps issue positions to numerical scores, and forms structured candidate feature vectors. The server outputs a candidate feature table that is aligned with issues and dimensions used in the prediction model.

### Step 10

The server executes a preference behavior simulation for election prediction.

The server receives as input persona objects and candidate feature data for a target electoral district.

The server iterates over persona objects, constructs input vectors combining persona attributes and each candidate's features, and feeds these vectors into the trained prediction model to compute vote probabilities. The server selects a candidate for each persona based on the computed probabilities, for example by choosing the candidate with the highest score. The server outputs simulated vote choices per persona.

### Step 11

The server aggregates simulated choices into election result prediction data.

The server receives as input the simulated vote choices produced for each persona and the mapping between personas and electoral districts.

The server counts the number of simulated votes per candidate in each district, computes vote share percentages and winning probabilities, and applies statistical methods such as bootstrap to estimate confidence intervals. The server outputs election result prediction data that includes, for each candidate and district, predicted vote share metrics and associated statistical indices.

### Step 12

The server formats prediction data for information distribution apparatuses using prompt sentences to a generative AI model.

The server receives as input the election result prediction data and information about output requirements of different information distribution apparatuses.

The server constructs a prompt sentence describing the desired tabular layouts, visual summaries, and narrative explanations, appends structured summaries of the prediction data, and sends this prompt sentence to the generative AI model. The server parses the returned text into tabular data, visualization descriptions, and explanatory text. The server outputs media provision prediction result data in formats suitable for consumption by external systems.

### Step 13

The server transmits prediction results to an information distribution apparatus.

The server receives as input the media provision prediction result data generated in the formatting step.

The server opens a communication session with an information distribution apparatus, sends the formatted data via an application protocol, and logs acknowledgment messages. The server outputs stored transmission logs and a status indicating successful provision of prediction results to the information distribution apparatus.

### Step 14

The server prepares advertisement information and an advertisement catalog.

The server receives as input raw advertisement content files and metadata such as topic, tone, medium, target audience descriptors, and cost parameters.

The server encodes this information into structured advertisement records, associates identifiers with each advertisement, and stores these records in an advertisement catalog database. The server outputs an indexed catalog of advertisement information ready for simulation and selection.

### Step 15

The server trains an advertisement response model.

The server receives as input historical interaction logs that associate user or persona attributes, advertisement attributes, and observed responses such as impressions, clicks, or conversions.

The server constructs training examples combining user or persona features with advertisement features, defines labels based on observed responses, and trains a neural network or similar model to approximate the probability of a positive response. The server outputs a trained advertisement response model that maps user-ad feature combinations to response degree predictions.

### Step 16

The server simulates advertisement responses using persona objects.

The server receives as input persona objects for a target segment and the advertisement catalog.

The server pairs persona attributes with each candidate advertisement, constructs combined feature vectors, and invokes the advertisement response model to compute predicted response degrees such as click-through rates. The server aggregates predicted responses across the target population for each advertisement. The server outputs evaluation metrics per advertisement that quantify expected effectiveness.

### Step 17

The server generates an advertisement placement plan based on simulation results.

The server receives as input the advertisement evaluation metrics, advertisement cost parameters, and any budget or policy constraints.

The server runs an optimization procedure that selects combinations of advertisements, channels, and scheduling that maximize an objective function, such as expected conversions under a given budget. The server outputs an advertisement placement plan specifying, for each segment and channel, which advertisements should be delivered and in what proportions.

### Step 18

The server refines advertisement strategies by interacting with a generative AI model via prompt sentences.

The server receives as input simulation summaries and the advertisement placement plan.

The server generates a prompt sentence that requests a human-readable strategy proposal or refinement, attaches key performance metrics, and sends this prompt sentence to the generative AI model. The server reads the textual response, extracts proposed messages or targeting refinements, and updates metadata or documentation associated with the advertisement placement plan. The server outputs a refined advertisement strategy that aligns numerical optimization with narrative descriptions.

### Step 19

The terminal acquires user attribute information and current context.

The terminal receives as input user registration data, device parameters, and user interactions such as page views, searches, or typed text.

The terminal compiles these items into a user attribute profile and a context snapshot, including fields such as age, gender, approximate location, and current app activity. The terminal outputs a context payload that it will send to the server for processing.

### Step 20

The terminal sends user emotional state information to the server.

The terminal receives as input user-generated text, such as comments, search queries, or posts entered through the terminal's user interface.

The terminal constructs a message containing the text and user identifier and transmits it to the server. The terminal outputs transmitted messages that allow the server to perform emotion analysis and update user emotional state information.

### Step 21

The server updates user profiles with emotion analysis results.

The server receives as input the text messages and user identifiers sent by the terminal.

The server invokes an emotion analysis function to obtain emotion scores or labels for each text, then merges these results into user profile records stored in the database, for example by updating a current emotional_state field and potentially maintaining a time series of recent states.

The server outputs updated user profiles that combine static attributes and dynamic emotional states.

### Step 22

The server selects a personalized advertisement for immediate delivery.

The server receives as input the updated user profile, the current advertisement placement plan, and the advertisement catalog.

The server filters advertisements based on basic eligibility, constructs feature vectors combining user attributes and advertisement attributes, and uses the advertisement response model to compute predicted response degrees. The server optionally consults a generative AI model by sending a prompt sentence that describes the user profile and candidate advertisements and requests a recommendation, then reconciles this recommendation with the model scores. The server outputs an identifier of a selected advertisement and associated presentation parameters.

### Step 23

The server transmits the selected advertisement information to the terminal.

The server receives as input the selected advertisement identifier and presentation parameters.

The server retrieves the corresponding advertisement content from storage, packages the content and parameters into a response message, and sends this message over the communication network to the terminal. The server outputs transmission records and a status of successful delivery.

### Step 24

The terminal displays or reproduces the advertisement and collects interaction data.

The terminal receives as input the advertisement content and presentation parameters from the server.

The terminal renders images, text, audio, or video on the display or speakers according to the provided parameters and logs user interactions such as views, clicks, or skips. The terminal outputs interaction logs, which it periodically transmits back to the server for further training and refinement of models.

### Step 25

The user initiates a scenario-based election prediction query.

The user receives as input a user interface on the terminal that allows free-text entry of a request.

The user types a query, such as a request to predict an election outcome under specified conditions, and submits it. The terminal sends this query text to the server as a scenario request.

The user outputs a natural-language description of the desired scenario.

### Step 26

The server interprets the user query and runs a scenario simulation.

The server receives as input the user's scenario query text, along with current prediction data, persona objects, and candidate feature data.

The server may construct a prompt sentence that incorporates the query and current system state, sends it to a generative AI model to derive scenario parameters, and parses the response to obtain changes such as turnout adjustments or emotion weighting factors. The server then reruns preference behavior simulations for the given scenario using updated parameters. The server outputs scenario-specific election result prediction data and any associated explanatory information.

### Step 27

The terminal presents scenario results to the user.

The terminal receives as input the scenario-specific prediction results and explanatory text from the server.

The terminal converts the results into visual elements such as tables and charts, displays summary text explaining key changes relative to baseline predictions, and allows the user to inspect details. The terminal outputs an updated user view that reflects the effects of the requested scenario.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

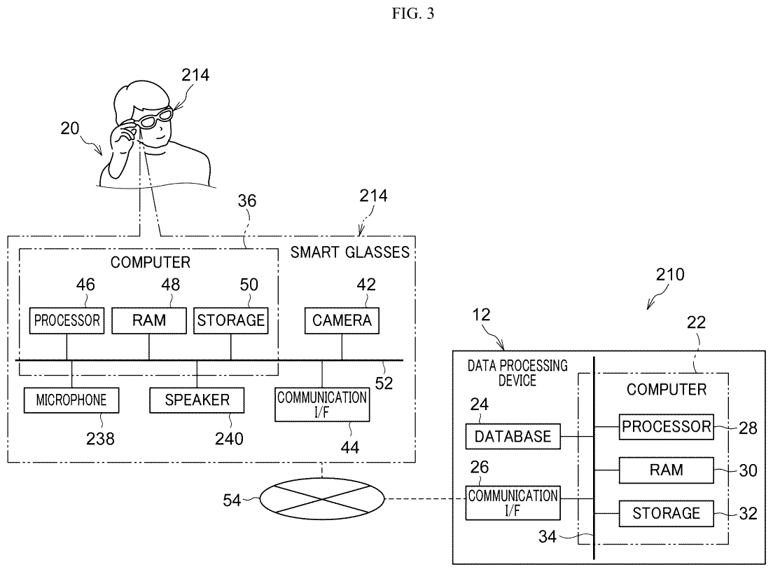

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

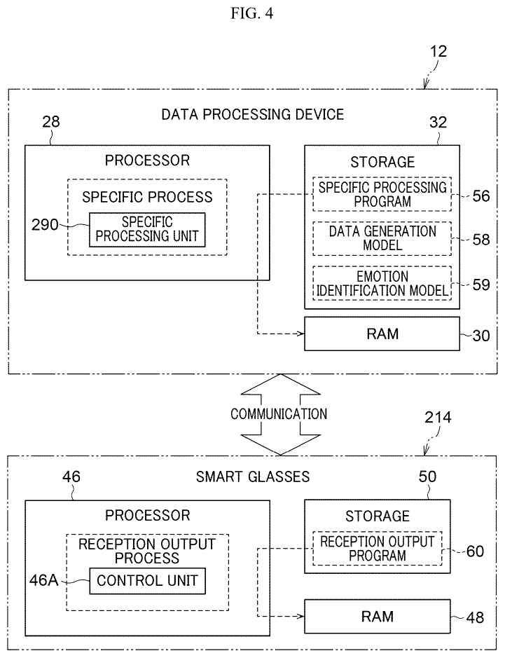

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

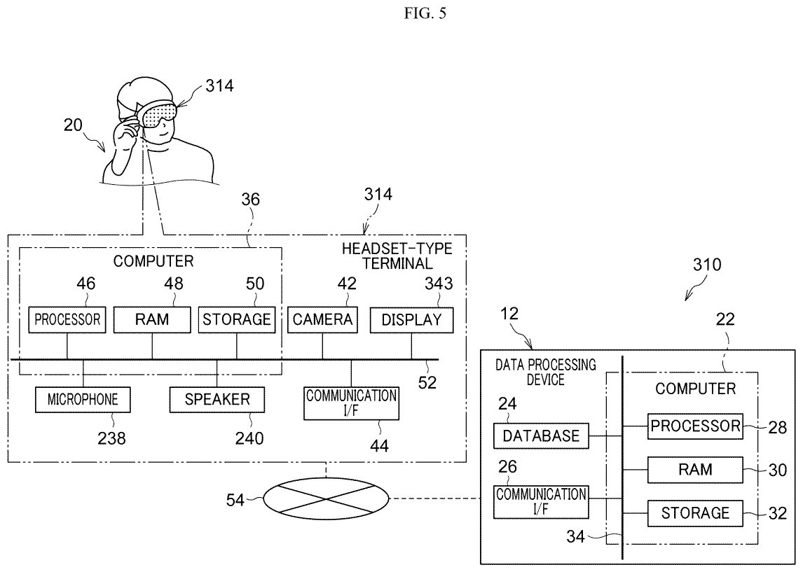

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

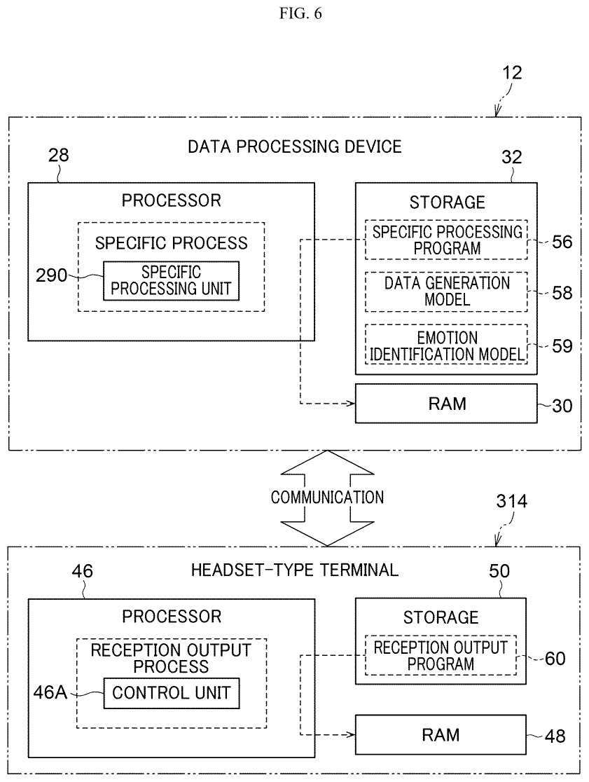

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

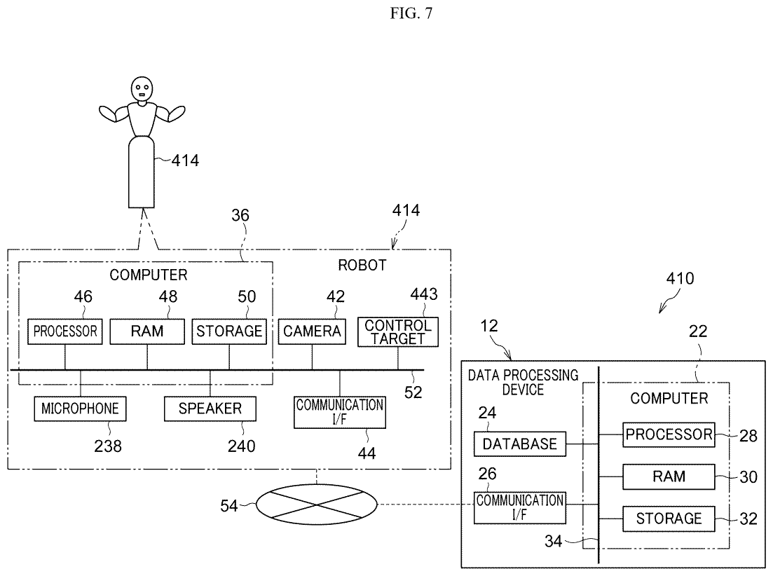

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

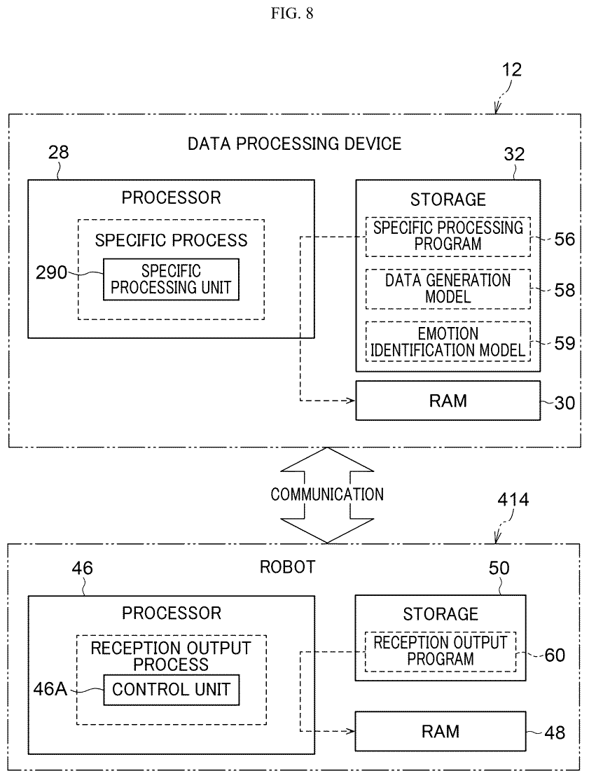

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

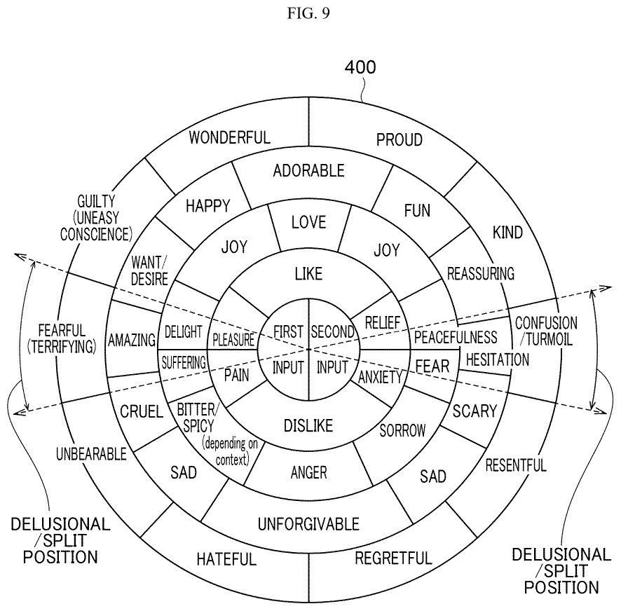

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

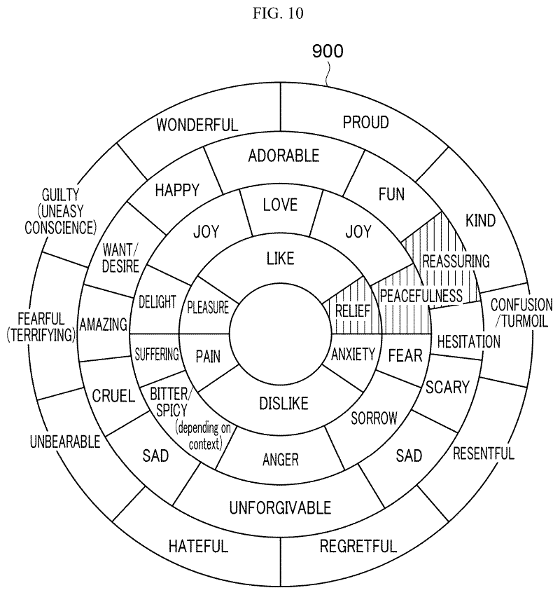

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire survey information and population statistics for each selection region, and store the survey information and the population statistics in a storage structure,
extract the survey information and the population statistics from the storage structure, and execute preprocessing using a general-purpose program execution environment and a data processing program section to generate a preprocessed data set, the preprocessing including at least completion of missing values, removal of abnormal values, normalization of categorical values, and aggregation processing,
generate a prompt sentence based on the preprocessed data set, the prompt sentence defining generation conditions and an output format for virtual individual information structures to be used for candidate prediction, and input the prompt sentence to a generative AI model so as to cause the generative AI model to generate a plurality of the virtual individual information structures,
analyze the virtual individual information structures output from the generative AI model, verify whether attribute values in the virtual individual information structures satisfy preset constraint conditions and value ranges, remove or correct virtual individual information structures that do not satisfy the constraint conditions, and register the verified virtual individual information structures in the storage structure,
apply a prediction model including a statistical estimation algorithm or a machine learning algorithm to the registered virtual individual information structures as input, calculate, for each virtual individual information structure, a preference probability for each candidate, and execute a simulation process that performs mock voting calculations a plurality of times based on the preference probabilities to predict an election result,
calculate, based on a result of the simulation process, at least one of a vote share, an elected candidate, and a reliability indicator for each selection region, generate a prompt sentence that defines analysis processing content and an output format for outputting the calculated result as at least one of tabular data for a notification apparatus, graphical information data, and structured data for a communication interface, and input the prompt sentence to the generative AI model so as to cause the generative AI model to generate explanation information and formatted output information for the calculated result, and
supply the explanation information and the formatted output information to an external apparatus in a format that is usable by at least one of a print notification medium, a video notification medium, and a communication notification medium.

### Supplementary 2

The system according to supplementary 1,
wherein the processor is configured to calculate, from the preprocessed data set, aggregated indicators including at least an age distribution, a gender ratio, an occupation distribution, and an education level distribution for each selection region, generate a prompt sentence describing the aggregated indicators, and input the prompt sentence to the generative AI model so as to cause the generative AI model to generate the virtual individual information structures reflecting the aggregated indicators.

### Supplementary 3

The system according to supplementary 1,
wherein the processor is configured to acquire configuration information specifying, for each notification target, at least one of an output format, a granularity, and explanatory content, based on the predicted result and the aggregated indicators, generate a prompt sentence reflecting the configuration information, and input the prompt sentence to the generative AI model so as to cause the generative AI model to provide the predicted result in a format suitable for at least one of a nationwide notification medium, a regional notification medium, and a video notification medium.

### Application Example 1

### Supplementary 1

A system comprising a processor and a memory,
wherein the processor is configured to
acquire, from a storage unit, small-scale preliminary survey data and demographic data for each electoral district, calculate attribute distributions based on the demographic data, and generate, in accordance with the attribute distributions, a plurality of personality objects each representing a virtual individual, by executing arithmetic processing,
segment, based on attribute conditions, the plurality of personality objects to extract a group of personality objects, perform aggregation processing on the extracted group to generate group information indicating attribute characteristics of the group, generate a prompt sentence including the group information and at least one of an advertising message or a survey question,
input the prompt sentence to a generative AI model, and obtain response information from the generative AI model, the response information including at least one of evaluation information or an improvement proposal relating to an election result or an advertising effect,
calculate, based on the response information and the plurality of personality objects, at least one of a predicted winning candidate in an election or an effectiveness index of an advertising campaign, rank a plurality of advertising messages in accordance with the effectiveness index, and generate output data for providing at least one of an election result prediction or an advertising message to an information medium, and
communicate with a terminal device, receive, from the terminal device, target conditions and an advertising message input by a user, and transmit, to the terminal device, result information including at least the evaluation information and the improvement proposal obtained from the generative AI model.

### Supplementary 2

The system according to supplementary 1,
wherein the processor is configured to
perform a simulation process that emulates a large-scale survey for each electoral district by using the plurality of personality objects, calculate, based on a probabilistic model or a statistical model, a support probability for each candidate, predict the winning candidate based on the support probability, and calculate an index for optimizing an advertising strategy for each target group by combining evaluation information relating to the advertising effect included in the response information from the generative AI model with an attribute distribution of the plurality of personality objects.

### Supplementary 3

The system according to supplementary 1,
wherein the processor is configured to
generate the prompt sentence to be input to the generative AI model by including, in the prompt sentence, a description of a target group comprising at least one of an age range, a gender, an occupation type, an education level, or a preference tendency derived from the group information of the plurality of personality objects, the advertising message input by the user, and an instruction sentence defining an evaluation method and an output format; analyze the response information from the generative AI model to extract at least one of an effectiveness score, analytical content, or a set of candidate messages; and provide the set of candidate messages to the terminal device in a format that allows comparison for each target group.

### Example 2

### Supplementary 1

A system comprising a processor,
wherein the processor is configured to
input, to a generative AI model, a prompt sentence that instructs generation of a personality data structure representing a virtual subject on the basis of survey result information for each region and demographic information,
store the personality data structure as structured data in a relational data storage area of an information storage device, and acquire the personality data structure and attribute information relating to a candidate object from the relational data storage area,
input, to the generative AI model, a prompt sentence that instructs execution of a simulation process that simulates preference behavior by comparing attribute information included in the personality data structure with the attribute information relating to the candidate object and determining, for each personality data structure, a candidate object to be supported, and
input, to the generative AI model, a prompt sentence that instructs generating analysis result data by aggregating, for each candidate object, a number of supports determined by the simulation process, identifying a candidate object having high likelihood of winning through statistical processing, and generating the analysis result data including the aggregation result and an identification result as tabular data or graphic display data and providing the analysis result data to an information distribution device.

### Supplementary 2

The system according to supplementary 1,
wherein the processor is configured to
generate, prior to generation of the personality data structure, a prompt sentence that specifies preprocessing content for summarizing or normalizing the survey result information and the demographic information and that explicitly defines attribute items and ranges of attribute values to be referred to by the generative AI model on the basis of the preprocessing content, and input the prompt sentence to the generative AI model.

### Supplementary 3

The system according to supplementary 1,
wherein the processor is configured to
receive the attribute information relating to the candidate object as a description text written in natural language, generate a prompt sentence that instructs execution of at least one similarity calculation process that converts the description text into a vector representation or converts preference information included in the personality data structure into a vector representation,
input the prompt sentence to the generative AI model, and determine the candidate object in the simulation process of the preference behavior on the basis of similarity between vector representations.

### Application Example 2

### Supplementary 1

A system comprising a processor,
wherein the processor is configured to
preprocess input information acquired from information sources including small-scale preliminary survey results for each electoral district, population attribute information, and emotion-related information, and to generate integrated feature data for each electoral district, and
generate a prompt sentence that instructs a generative AI model to generate a plurality of virtual individual data for each electoral district based on the integrated feature data, and input the prompt sentence into the generative AI model to obtain person objects or virtual individual objects having attributes including age, gender, occupation, education level, and emotional state, and
generate a prompt sentence that instructs the generative AI model to perform a preference behavior simulation that mimics a large-scale survey by associating the obtained person objects or virtual individual objects with policy information or attribute information of candidate entities and calculating, for each candidate entity, a vote probability or winning probability, and input the prompt sentence into the generative AI model, and
aggregate results of the preference behavior simulation to generate election result prediction data including statistical indices and confidence intervals, and
generate a prompt sentence that instructs the generative AI model to generate, based on the election result prediction data, report data or provision data having different output formats for respective information provision targets, and input the prompt sentence into the generative AI model to generate media provision prediction result data including tabular data, visualization data, and descriptive text data, and
output the media provision prediction result data to an information distribution apparatus via a communication path so that the media provision prediction result data is used for reporting or distribution by the information distribution apparatus, and
generate a prompt sentence that instructs the generative AI model to perform a simulation for estimating a response degree to advertisement information based on combinations of the person objects or virtual individual objects and the advertisement information and for optimizing an advertisement placement plan or advertisement content, and input the prompt sentence into the generative AI model, and
select advertisement information to be presented to a user from among the advertisement placement plan or the advertisement content based on user attribute information and user emotional state information acquired from a terminal device, and
transmit the selected advertisement information to the terminal device so that the advertisement information is displayed or reproduced on the terminal device.

### Supplementary 2

The system according to supplementary 1,
wherein the processor is configured to
generate a prompt sentence that instructs the generative AI model to include group emotion information or user emotional state information, extracted by an emotion analysis function, in the integrated feature data in generation of the person objects or the virtual individual objects and in execution of the preference behavior simulation, and input the prompt sentence into the generative AI model so as to generate election result prediction data reflecting emotional states.

### Supplementary 3

The system according to supplementary 1,
wherein the processor is configured to
generate a prompt sentence that instructs the generative AI model to provide, to the information distribution apparatus, the media provision prediction result data in association with the advertisement placement plan, such that election result prediction information and advertisement optimization information based on the election result prediction information are provided together, and input the prompt sentence into the generative AI model.

What is claimed is:

1. A system comprising:
circuitry configured to:
acquire, via a communication interface coupled to a packet-switched network, sample data and population attribute statistics for each evaluation region from a storage device, and execute preprocessing comprising at least completion of missing values, removal of abnormal values, normalization of categorical values, and aggregation processing to generate a preprocessed data set;
generate a first prompt sentence based on the preprocessed data set, the first prompt sentence defining generation conditions and an output format for attribute profile structures, input the first prompt sentence to a generative neural network model, and cause the generative neural network model to generate a plurality of the attribute profile structures each representing a virtual individual;
verify whether attribute values in the attribute profile structures satisfy preset constraint conditions and value ranges, remove or correct attribute profile structures that do not satisfy the constraint conditions, and register verified attribute profile structures in the storage device;
apply a prediction model comprising at least one of a statistical estimation algorithm or a machine learning algorithm to the verified attribute profile structures, calculate for each attribute profile structure a preference probability for each target entity, and execute a simulation process that performs preference calculations a plurality of times based on the preference probabilities to predict an outcome result;
generate a second prompt sentence defining analysis processing content and an output format, input the second prompt sentence to the generative neural network model, and cause the generative neural network model to generate explanation information and formatted output information for the outcome result; and
transmit a notification data packet comprising the explanation information and the formatted output information to an external apparatus via the communication interface.

2. The system according to claim 1, wherein the circuitry is configured to calculate, from the preprocessed data set, aggregated indicators comprising at least an age distribution, a gender ratio, an occupation distribution, and an education level distribution for each evaluation region, and to generate the first prompt sentence describing the aggregated indicators to cause the generative neural network model to generate the attribute profile structures reflecting the aggregated indicators.

3. The system according to claim 2, wherein the circuitry is configured to segment the plurality of attribute profile structures based on attribute conditions to extract a group, perform aggregation processing on the extracted group to generate group information indicating attribute characteristics, and generate a prompt sentence including the group information for input to the generative neural network model.

4. The system according to claim 1, wherein the generative neural network model comprises a transformer-based architecture including multiple self-attention layers and feed-forward layers, and wherein the circuitry is configured to control at least one of a temperature parameter or a top-k sampling threshold during generation of the attribute profile structures.

5. The system according to claim 1, wherein the prediction model comprises a probabilistic model that calculates a support probability for each target entity based on attribute matching between the attribute profile structures and target entity attribute information, and wherein the simulation process comprises a Monte Carlo simulation executing the preference calculations a predetermined number of iterations.

6. The system according to claim 5, wherein the circuitry is configured to calculate, based on the simulation process result, at least one of a share proportion, a predicted outcome entity, and a reliability indicator for each evaluation region.

7. The system according to claim 1, wherein the circuitry is configured to acquire configuration information specifying, for each notification target, at least one of an output format, a granularity, or explanatory content, and to generate the second prompt sentence reflecting the configuration information to cause the generative neural network model to provide the outcome result in a format suitable for at least one of a nationwide notification medium, a regional notification medium, or a broadcast notification medium.

8. The system according to claim 1, wherein the attribute profile structures comprise structured data stored in a relational data storage area of the storage device, each attribute profile structure comprising at least an age value, a gender value, an occupation value, an education level value, and a preference tendency value.

9. The system according to claim 8, wherein the circuitry is configured to acquire attribute information relating to each target entity from the storage device, and to calculate preference alignment by comparing attribute information of the attribute profile structures with the target entity attribute information using a similarity metric.

10. The system according to claim 9, wherein the circuitry is configured to convert a description text of the target entity into a vector representation, convert preference information in the attribute profile structures into a vector representation, and compute a similarity score between the vector representations.

11. The system according to claim 1, wherein the circuitry is configured to receive, from a terminal device via the communication interface, target conditions and content data input by a user, generate a prompt sentence including group information derived from the attribute profile structures and the content data, and input the prompt sentence to the generative neural network model to obtain evaluation information comprising at least one of an effectiveness index or an improvement proposal.

12. The system according to claim 11, wherein the circuitry is configured to rank a plurality of content items in accordance with the effectiveness index calculated using the evaluation information and attribute distributions of the attribute profile structures, and transmit ranking results to the terminal device.

13. The system according to claim 1, wherein the formatted output information comprises at least one of tabular data, graphical information data, or structured data for the communication interface, and wherein the explanation information comprises a natural language description of the outcome result generated by the generative neural network model.

14. The system according to claim 1, wherein the circuitry is configured to generate the first prompt sentence by including an instruction sentence defining an evaluation method and an output format, a description of attribute distributions derived from the preprocessed data set, and constraint conditions for the attribute profile structures.

15. The system according to claim 1, wherein the circuitry is configured to store the outcome result and the simulation process parameters in the storage device as history information, and to use the history information for subsequent model update processing or constraint refinement.

16. The system according to claim 1, wherein the circuitry is configured to estimate an emotional state of a user based on at least one of audio data or facial image data received from a terminal device, and to adjust at least one of a granularity or an explanatory depth of the formatted output information based on the estimated emotional state.

17. The system according to claim 1, wherein the circuitry is configured to receive the sample data from a terminal device of the external apparatus, wherein the sample data comprises response records from a preliminary survey including at least preference indication data and demographic attribute data for respondents.

18. A system comprising:
circuitry configured to:
acquire, via a communication interface coupled to a packet-switched network, sample data and population attribute statistics for each evaluation region, execute preprocessing comprising missing value completion, abnormal value removal, and categorical normalization to generate a preprocessed data set, and calculate aggregated indicators comprising at least an age distribution and an occupation distribution for each evaluation region;
generate a first prompt sentence describing the aggregated indicators and generation conditions, input the first prompt sentence to a generative neural network model comprising a transformer-based architecture, cause the generative neural network model to generate a plurality of attribute profile structures, verify constraint compliance of the attribute profile structures, and register verified attribute profile structures in a storage device;
apply a prediction model comprising a statistical estimation algorithm to the verified attribute profile structures, calculate preference probabilities for each target entity, and execute a simulation process comprising a plurality of preference calculation iterations to predict an outcome result including at least a share proportion and a predicted outcome entity for each evaluation region;
generate a second prompt sentence defining analysis content, an output format, and a notification target specification, input the second prompt sentence to the generative neural network model, and cause the generative neural network model to generate explanation information and formatted output information in at least one of a tabular format, a graphical format, or a structured data format; and
transmit a notification data packet comprising the explanation information and the formatted output information to an external apparatus via the communication interface.

19. The system according to claim 18, wherein the circuitry is configured to receive target conditions and content data from a terminal device, segment the attribute profile structures based on the target conditions, generate a prompt sentence including group information and the content data, and obtain evaluation information comprising an effectiveness index from the generative neural network model.

20. A method comprising:
acquiring, via a communication interface coupled to a packet-switched network, sample data and population attribute statistics for each evaluation region from a storage device, and executing preprocessing comprising at least completion of missing values, removal of abnormal values, normalization of categorical values, and aggregation processing to generate a preprocessed data set;
generating a first prompt sentence based on the preprocessed data set, inputting the first prompt sentence to a generative neural network model, and causing the generative neural network model to generate a plurality of attribute profile structures each representing a virtual individual;
verifying whether attribute values in the attribute profile structures satisfy preset constraint conditions, removing or correcting non-compliant attribute profile structures, and registering verified attribute profile structures in the storage device;
applying a prediction model comprising at least one of a statistical estimation algorithm or a machine learning algorithm to the verified attribute profile structures, calculating preference probabilities for each target entity, and executing a simulation process to predict an outcome result;
generating a second prompt sentence defining analysis processing content and an output format, inputting the second prompt sentence to the generative neural network model, and causing the generative neural network model to generate explanation information and formatted output information for the outcome result; and
transmitting a notification data packet comprising the explanation information and the formatted output information to an external apparatus via the communication interface.
